(19) United States
(12) Patent Application Publication
(10) Pub. No.: US 2026/0022689 A1
(43) Pub. Date: Jan. 22, 2026

(54) Utilizing the Bland/Ewing Cycle as a Thermochemical Gas Compressor

(71) Applicant: Joseph Barrett Bland, Sacramento, CA (US)

(72) Inventor: Joseph Barrett Bland, Sacramento, CA (US)

(21) Appl. No.: 19/275,589

(22) Filed: Jul. 21, 2025

Related U.S. Application Data
(60) Provisional application No. 63/674,261, filed on Jul. 22, 2024.

(51) Int. Cl. F03G 7/00

(52) U.S. Cl. CPC F03G 7/00

(57) ABSTRACT

The present application relates to systems and methods for utilizing the Bland/Ewing cycle as a thermochemical gas compressor. In some examples, it can be useful to view the Bland/Ewing Cycle as including two thermodynamic half cycles, which include an endothermic half cycle and an exothermic half cycle, as discussed herein.

### CROSS-RELATED TO RELATED APPLICATIONS

This application claims priority to, and the benefit of, U.S. Provisional Application No. 63/674,261, filed on Jul. 22, 2024, the entire content of which is hereby incorporated by reference.

### BACKGROUND

Reference is made herein to U.S. Pat. Nos. 3,225,538, 3,067,594, and 3,871,179, and to U.S. patents application Ser. Nos. 17/746,848 (corresponding to U.S. Publication No. 2024/0352875), 18/095,463 (corresponding to U.S. Publication No. 2025/0116259), 18/197,092 (corresponding to U.S. Publication No. 2023/0382725), and 18/362,951 (corresponding to U.S. Publication No. 2024/0044566). When referred to in the following, they will be referenced by their number. Each of these patents, patent applications, and patent application publications is incorporated herein by reference.

In Ser. No. 18/362,951, FIG. 23, a simple system is proposed for generating high pressure H2 which does not require a physical compression process. Essentially, a high-pressure gas is generated from a continually recycling and thus essentially reversible chemical carrier. In the example used throughout, C6H12 is proposed as a carrier for H2, releasing H2 via an endothermic catalytic reaction which converts each mol of C6H12 into a mol of C6H6 and three moles of H2.The conversion is reversible via an exothermic catalytic reaction that converts a mol of C6H6 and three moles of H2 back into C6H12. This cyclically reversible concept is the basis of the Bland/Ewing Thermochemical Cycle (B/E Cycle), as disclosed in U.S. Pat. No. 3,225,538, specifically as shown in FIG. 1 through FIG. 4 of that patent. It has recently been found useful to view the B/E Cycle as composable from two thermodynamic “half cycles”; that is, an “endothermic half cycle” if an endothermic reaction is key to the process, and an “exothermic half cycle” if an exothermic reaction is key to the process, as will be shown. Generally speaking, an endothermic half-cycle is a “work out” (Wout) cycle requiring some “heat in” (Hin), while an exothermic half-cycle is a “heat out” (Hout) half-cycle that requires some “work in” (Win). Note, however, that heat can be used to completely power or assist in powering an external work-producing heat engine. Used in that manner, an exothermic half-cycle can be seen as potentially producing Wout in addition to the Wout of an endothermic half-cycle, that is, the use of a B/E Cycle's exothermically-produced heat can be considered a means of increasing overall thermal efficiency of an original B/E Cycle. It is therefore akin to an original B/E Cycle feeding its exothermic heat output to a “bottoming cycle” engine, which is a secondary heat engine that uses “waste thermal energy” from a primary heat engine to produce additional Wout. Also, in Ser. No. 18/362,951, specifically starting at paragraph 623, use of a thermochemical gas pump, in this instance for H2, is proposed as a means of pressurizing H2 gas for use in a cyclical expansion refrigeration system, in this instance expanding H2 gas. It is proposed in Ser. No. 18/362,951 that, following the pressurized endothermic catalytic conversion of C6H12 to C6H6 and H2, and following a liquefaction and removal of C6H6 and a cooling of the H2 to ambient temperatures, the separated pressurized H2 may be adiabatically expanded to a lower pressure and thus lower than ambient temperature, thus constructing a kind of thermochemical cooling system. Presently, the well-known Siemens refrigeration cycle is used for reaching these low temperatures, which requires use of a physical compressor and considerable net work in (Win). In contrast, a “B/E Chemical Pump Refrigeration half-cycle” (1) uses a combination of thermal input and a liquid pump for “compression”, while (2) simultaneously generating net work out (Wout), as will be shown. For even greater refrigeration, the H2 can be cooled to the lowest practicable temperature possible prior to expansion, for example by the removal of heat via the extremely cold regions called Permanently Shadowed Regions (PSRs) found at the Moon's poles. Also, it has been discovered that the higher the pressure at which the gas is thermochemically liberated, the lower the gas expansion can drop the final temperature below the lowest practicable temperature possible. Additionally, the higher endothermic temperature required by such increased pressure increases the potential thermal efficiency of the endothermic half-cycle that releases the stored gas, since more net Wout can be generated relative to a given amount of thermal source energy added.

### Essential Quantities

C6H12 mass—84.162 g/mol
C6H6 mass—78.114 g/mol
C mass—12.001 g/mol
H2 mass—2.016 g/mol
100% C6H12 converting to 100% C6H6+3H2 chemically absorbs ˜52.28 kcal/mol (218.7 kJ/mol) of C6H12, and vice versa.
The liquid molar heat capacity of C6H12 is equal to 156 J/(mol K).
The liquid molar heat capacity of C6H6 is equal to 135 J/(mol K).
The vapor molar heat capacity of C6H12 is equal to 105 J/(mol K).
The vapor molar heat capacity of C6H6 is equal to 82.4 J/(mol K).
H2 has a (vapor) molar heat capacity of 28.84 J/(mol K).
H2 (vapor) heat capacity for 3 moles equals 86.5 J/K.
C6H12 has 21 J/(mol K) more liquid heat capacity than the C6H6 liquid heat capacity.
C6H12 has 22.6 J/(mol K) more vapor heat capacity than the C6H6 vapor heat capacity.
C6H12 boils at 1 Atm and 353.9 K (637.0 R).
C6H6 boils at 1 Atm and 353.2 K (635.8 R).
C6H12 has a standard heat of vaporization requirement of 32 kJ/mol/(K), or (32×11.9=) 380 kJ/kg.
C6H6 has a standard heat of vaporization requirement of 33.9 kJ/mol/(K), or (33.9×12.8=) 433 kJ/kg.
C6H12 vapor has 21 J/(mol K) more heat capacity than C6H6 vapor, C6H12 liquid has 22.6 J/(mol K) more heat capacity than C6H6 liquid, but C6H6 has 1.9 kJ/mol more heat of condensation than C6H12.
The C6H6 liquid-vapor critical point, which is the end point of the pressure-temperature curve that designates conditions under which a liquid and its vapor can coexist, equals 562 K (1,012 R) at a pressure of 48.3 Atm (4,890 kPa).
The C6H12 liquid-vapor critical point equals 554 K (997 R) at a pressure of 40.2 Atm (4,070 kPa).

### BRIEF DESCRIPTION OF THE DRAWINGS

FIG. 1 is based on FIG. 1, U.S. Pat. No. 3,225,538, which is “a graph showing a series of curves for equilibrium conditions respectively in terms of constant conversion to benzene, in the reversible chemical reaction of cyclohexane on the one hand and benzene and hydrogen on the other hand, the coordinates being temperatures and the logarithms of pressures.” In the present case, FIG. 1 is used to create a first order estimate of various specific temperatures at various specific pressures either required for an endothermic reaction of either 99% or 90% completion or for an exothermic reaction of either 99% or 90% completion.

FIG. 2 is a closeup of a graphic placed upon FIG. 1 that allows the logarithmic differences in pressures to be more easily determined.

FIG. 3 is similar to FIG. 18 in U.S. patent application Ser. No. 18/362,951 and illustrates a pressure/volume/temperature/energy/entropy chart based on FIG. 70, “Marks Mechanical Engineers' Handbook”, 1st edition, 9-148, “Internal-combustion engines”, upon which tracings have been added to help illustrate working states of various cycles and half-cycles disclosed herein.

FIG. 4 illustrates the tracings, curves, lines, and quantities in FIG. 3 separated out for ease of analysis purposes.

FIG. 5 is taken from USPTO application Ser. No. 18/362,951 and illustrates phase one of a two phase simple “synchronized thermal regenerator exchange pump” (STREP) process suitable for efficiently exchanging heat between two counter-flowing streams of fluid at constant pressure.

FIG. 6 illustrates phase two of the STREP shown in FIG. 5.

FIG. 7 illustrates a typical Bland/Ewing Chemical Pump Refrigeration Full Cycle.

### DETAILED DESCRIPTION

Table 1 generally defines a vaporization curve for both C6H6 (benzene) and C6H12 (cyclohexane).

TABLE 1
Equilibrium vapor pressure chart for C6H12

| Pressure | Pressure | Temp. in | Temp. in |
|---|---|---|---|
| in mm Hg | in psi | deg K | deg R |
| 1 | 0.0193 | 228 | 410 |
| 19 | 0.193 | 257 | 463 |
| 40 | 0.773 | 280 | 504 |
| 100 | 1.93 | 299 | 538 |
| 400 | 7.73 | 334 | 601 |
| 760 | 14.7 | 354 | 637 |
| 1520 | 29.4 | 379 | 682 |
| 3800 | 73.5 | 419 | 754 |
| 7600 | 147 | 457 | 822 |
| 15200 | 294 | 500 | 900 |
| 31000 | 600 | 572 | 1030 |

Graph 1 illustrates a generally defined vaporization curve developed from the data in Table 1 that may be utilized to generate first order estimates for both C6H6 (benzene) and C6H12 (cyclohexane).

### Basic Exothermic Half-Cycles

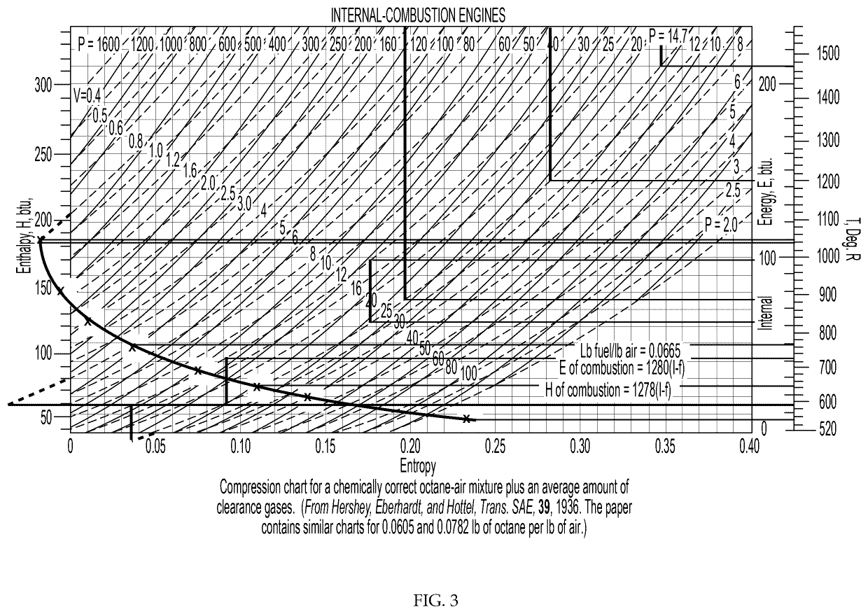

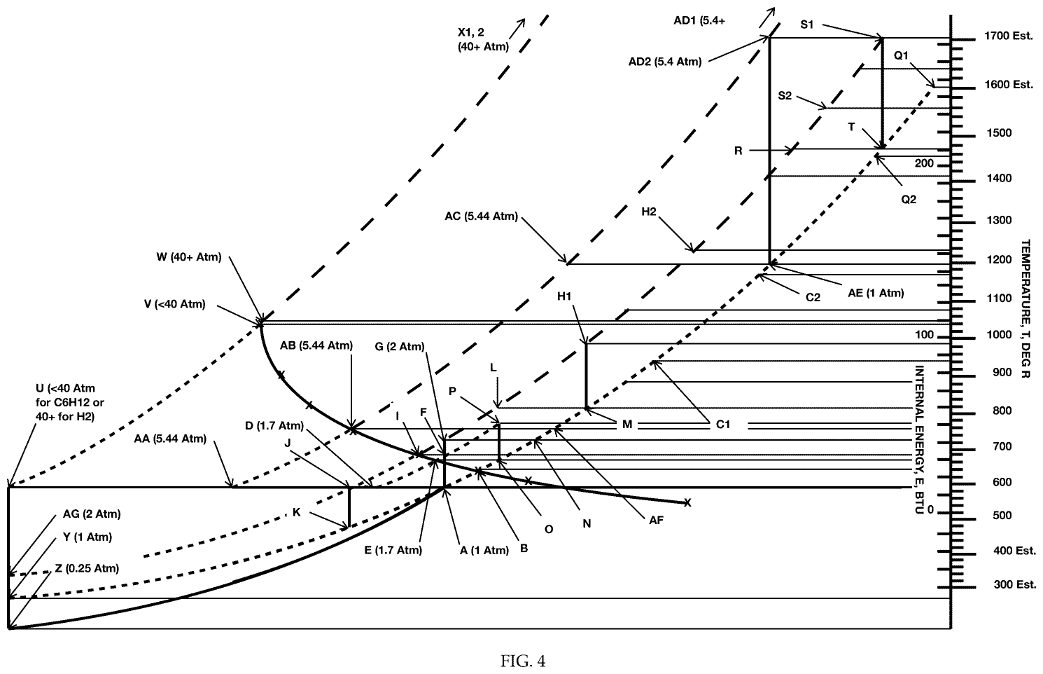

FIG. 3 and FIG. 4 show us the vaporization temperatures for C6H12 at various pressures, shown as the curved vaporization line along points B, E, I, AB, V. Note that vaporization temperatures/pressures for C6H6 are only slightly different from those for C6H12. Therefore, the vaporization line illustrates a fair approximation of both C6H12 and C6H6, and will be used to illustrate estimated data and generate estimated data for both hydrocarbons.) The C6H12 vaporization curve is taken from the data in Table 1.

### Mono-Pressure Exothermic Half-Cycle

The simplest exothermic half-cycle, termed a “mono-pressure exothermic half-cycle”, assumes that the product mix C6H6+3H2 is made available at 1 Atm, shown in FIG. 3 and FIG. 4 by the curved line through the points labeled in FIG. 4A, B, C1 (or C2), B, A, where the vaporization line at point B indicates that C6H6 at 1 Atm boils/condenses at about 356 K (640 R). In this half-cycle, no compression work is required other than basic pumping work, since the pressure doesn't change. (Note: For purposes of this analysis throughout, it is assumed that the “ambient” temperature on Earth (that is, the temperature that gases are initially brought in at and cooled to) equals 322 K (580 R, 49 deg C., 120 deg F.). This is higher than the average temperature on Earth, but assumes it is possible essentially anywhere to relatively easily cool gases to that temperature.)

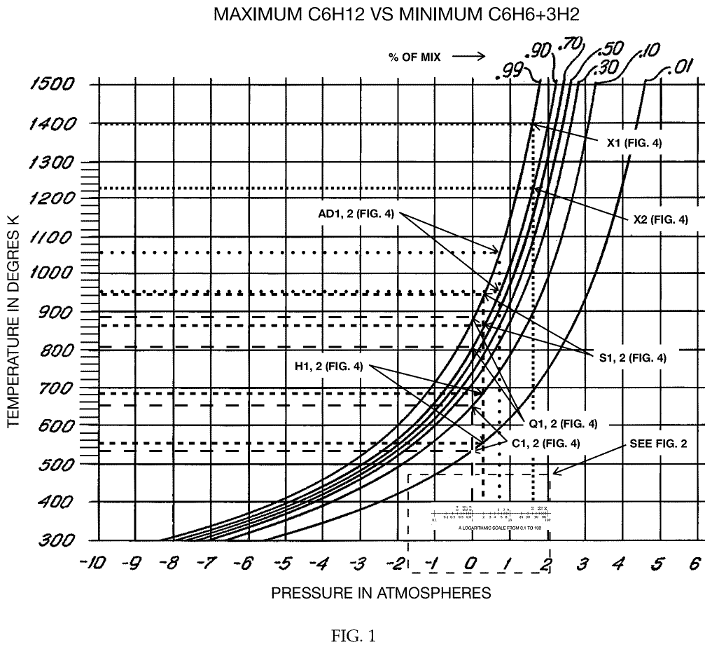

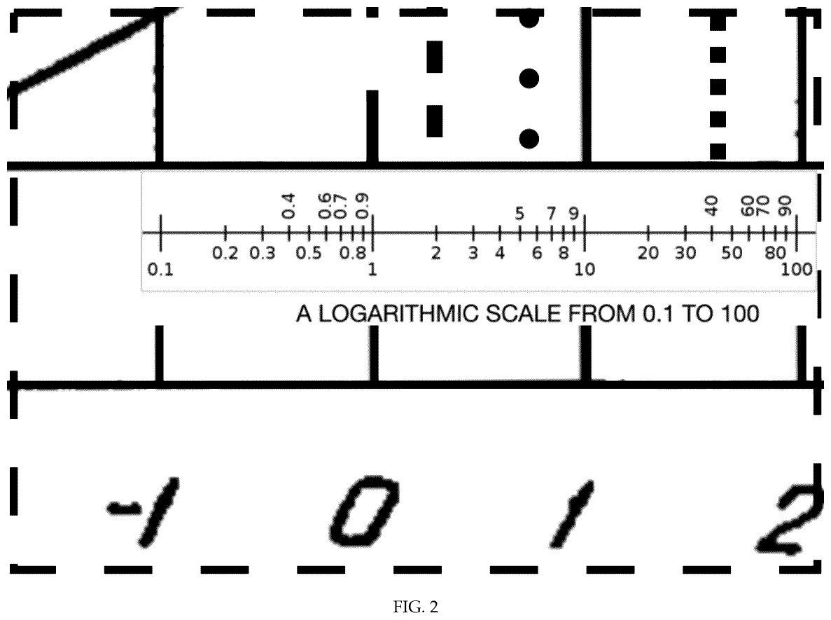

Per FIG. 1 (based on FIG. 1, U.S. Pat. No. 3,225,538), at 1 Atm and approximately 530 K (954 R), it is assumed that the catalytic union of 1 mol of C6H6 (product) and 3 moles of H2 (product) creates an essentially 100% complete conversion to 1 mol of C6H12 (reactant) (see FIG. 1 and FIG. 4, point C1). At about 650 K (1,170 R) and 1 Atm, a 90% complete union is created (see FIG. 1 and FIG. 4, point C2). In addition, it is known, from No. 3,225,538, that the highly reversible C6H12<=>C6H6+3H2 reaction absorbs or produces 218.7 kJ/mol of thermal energy at any temperature/pressure state defined within FIG. 1, U.S. Pat. No. 3,225,538. (Note that FIG. 2, U.S. Pat. No. 3,225,538 shows the relationship between temperature and specific heat, or the heat capacity of a sample of the substance divided by the mass of the sample. That is, FIG. 2, U.S. Pat. No. 3,225,538 notates changes in specific heat at various constant pressures, mapped in FIG. 1 per changes in degrees Kelvin. (Note that any temperature/pressure state thus “maps” the specific heat of a combined mix of C6H12, C6H6, and 3H2), and that any constant adiabatic/isentropic drop maps the drop in temperature and concomitant pressure for that mix. Thus, at 530 K and 1 Atm, 1 mol of C6H6+3H2 mix yields 1 mol of C6H12 at constant temperature and volume, which reduces the specific heat of the mix from about 48 to about 12 or about 25%. On the other hand, at 1,500 K, the specific heat of 100% C6H12 equals about 20, while the specific heat of a 100% C6H6+3H2 mix equals about 90, or about 4.5× higher. And since conversion of one to the other occurs at both constant temperature and constant pressure, this literally maps a massive decrease or increase in specific heat of the mix due to the thermochemical conversion at that temperature and pressure.)

To create that exothermic reaction, the C6H6 and H2 will first need to be raised from 322 K to the exothermic temperature. While H2 gas only needs to be preheated, C6H6 is a liquid at 322 K, and it must first be raised to the temperature of vaporization, then vaporized, then preheated. Assuming an exothermic reaction temperature of 530 K (point C1), we can calculate the thermal energy required to preheat the C6H6 and H2 product from the information given above under “Essential quantities” as equal to:
322 K to 354 K total C6H6 molar liquid heat capacity=4.6 kJ.
354 K C6H6 molar vaporization requirement=33.9 kJ.
354 K to 530 K total C6H6 molar vapor heat capacity=14.5 kJ

Similarly, we can calculate the thermal energy required for preheating 3 moles of H2 as equal to:
322 K to 530 K total H2 molar vapor heat capacity=18.0 kJ.

Following the conversion, the latent thermal energy in the C6H12 reactant exiting the exothermic reactor can potentially be used to preheat the C6H6 or H2 product. Again, we can calculate the thermal energy produced by cooling the C6H12 reactant:
530 K to 354 K total C6H12 molar vapor heat capacity=18.5 kJ.
354 K C6H12 molar condensation requirement=32 kJ
354 K to 322 K total C6H12 molar liquid heat capacity=5.0 kJ.

As can be seen, there is more than enough thermal energy available in the C6H12 vapor to preheat vaporized C6H6 from 354 K to 530 K, yielding a potential 36 kJ of available thermal energy at 354 K. That is theoretically more than enough condensation heat plus vapor heat capacity to supply the thermal energy required to vaporize the C6H6 when raised to its vaporization temperature, although some additional cooling will be required to condense all the C6H12 vapor into liquid. Finally, there is more than enough thermal energy available in the C6H12 liquid heat capacity alone to preheat the C6H6 liquid to its vaporization temperature.

However, the C6H12 condenses at less than a degree above the vaporization temperature of the C6H6, releasing 32 kJ in the process, so it is likely not practical to use the 1 Atm C6H12 condensation energy to vaporize the 1 Atm C6H6. As a result, to complete this particular exothermic half-cycle's vaporization requirement, it would appear to be necessary to “borrow” from elsewhere the 34 kJ thermal energy at a temperature in excess of 354 K required to vaporize 1 mol of C6H6 at 1 Atm.

In a “Mono-pressure exothermic half-cycle” exothermic reaction, the C6H6+3H2 is converted into C6H12, thus “releasing” 218.7 kJ of stored thermal energy at 530 K for a 99% conversion, at the thermal cost of requiring 34 kJ of source heat at a temperature over 354 K, or about 16% of the thermal energy released in the exothermic reaction.

### Bi-Pressure Exothermic Half-Cycle

A second approach to building an basic exothermic half-cycle, termed a “bi-pressure exothermic half-cycle”, is shown in FIG. 4 by the lines through the points A, D, E, F, G, H1 (or H2), I, J, A. In such a half-cycle, an Exothermic Reactor Exhaust Compressor (EREC) is added, as proposed in Ser. No. 18/095,463. An EREC is a low pressure-differential compressor that is used to assist in the vaporization of C6H6 by a counter-flowing exchange of heat with condensing higher pressure C6H12. The EREC is used to boost the C6H6 vapor pressure immediately following vaporization, in this example at about 1.7 Atm (25 psi), to a higher pressure, in this example 2 Atm (29.4 psi). That 0.3 Atm higher pressure is in turn assumed to permit condensation of a 2 Atm C6H12 stream at a sufficiently higher temperature than the C6H6 stream's vaporization temperature to force vaporization to completion.

Per FIG. 4, just prior to compression beginning at a pressure of 1.7 Atm, the vaporizing C6H6 equals a temperature of about 372 K (670 R) (point F). The Omni Combined Gas Law Calculator (CGLC) www.omnicalculator.com is used to calculate theoretical states. For a first-order calculation, CH4 (methane) was used as a substitute for C6H12 and C6H6 to calculate volumes and temperatures at various pressures. Per the CGLC, 1 mol of CH4 at 372 K and 1.7 Atm has a beginning volume of 18.0 L.

Assuming that the EREC compressor is a positive displacement compressor, the intake Wout of 18 L of 1 mol of C6H6 vapor at 372 K and 1.7 Atm can be calculated by using the pressure and volume change. Since 1.7 Atm equals 25 psi and 18 L equals 0.636 cu ft or 1 ft of travel times 0.636 sq ft or 91.6 sq in of piston area, total force from the intake process at constant pressure thus equals 25 psi times 91.6 sq in or 2,290 lbs over 1 ft of travel or 2,290 ft lbs or about 3.1 kJ Wout. Note that this work is essentially the same regardless of the type of vapor/gas supplying the work at constant pressure and temperature.

Per the CGLC, CH4 compression from 1.7 Atm (point F) to 2 Atm (point G) has an ending volume of 15.9 L (0.562 cu ft), a final temperature of 386 K, and a required force of about 0.39 kJ Win.

We can calculate the force required to pump the compressed C6H6 vapor out of the compressor by using the calculated volume remaining at 2 Atm, or 15.9 L (0.562 cu ft). Total exhaust force equals 2 Atm or 29.4 psi times 80.9 sq in (0.562 sq ft) over 1 foot of travel or 2,380 ft lbs or about 3.2 kJ Win.

Total EREC Win equals (isobaric compression Win at 1.7 Atm and exhaust Win at 2.0 Atm minus intake Wout at 1.7 Atm) 0.5 kJ.

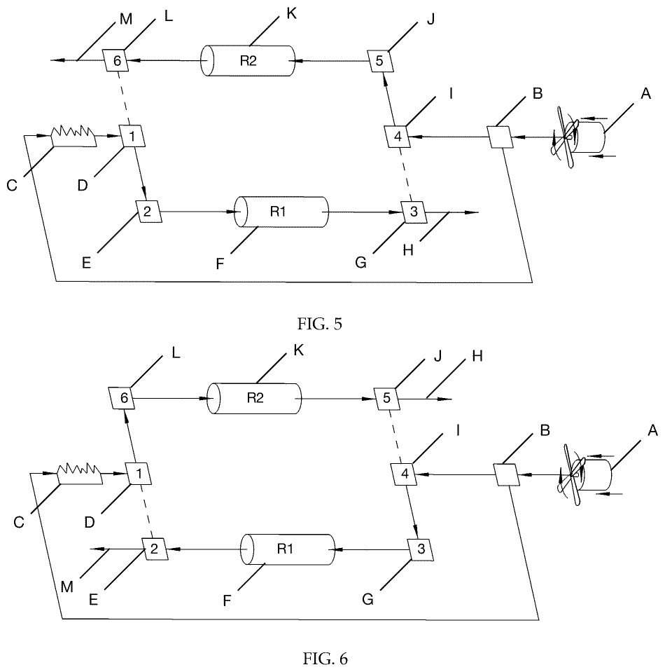

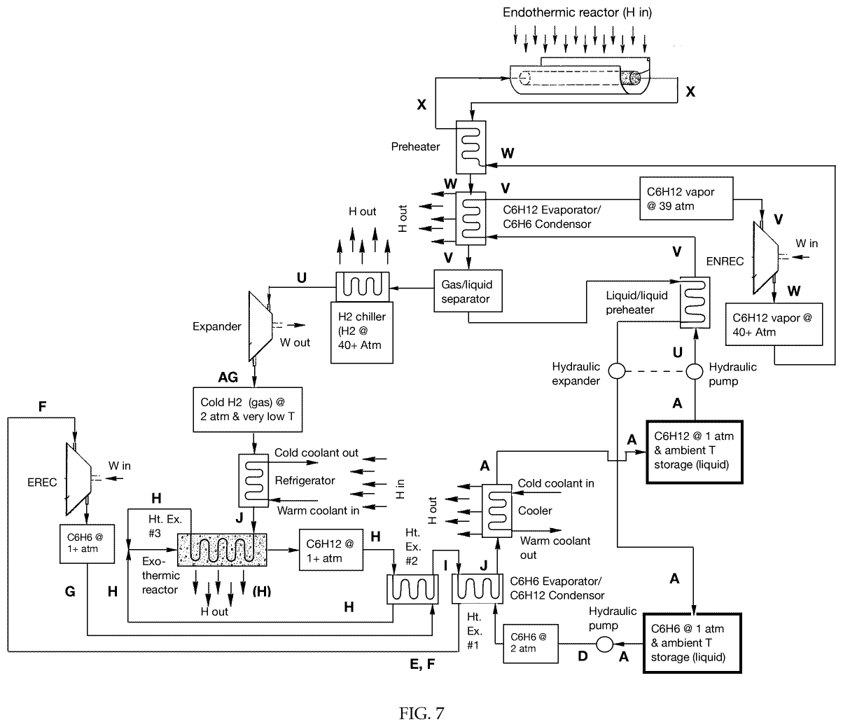

A particularly efficient means for tapping into the proposed excess “condensation thermal energy” is disclosed in Ser. No. 18/362,951, specifically the use of a “synchronized thermal regenerator exchange pump” (STREP). In this application, a quantity of the colder stream of C6H6 is passed through a heated regenerator core, heating the C6H6 to vapor, and simultaneously cooling the regenerator core. Next, a quantity of a hotter, higher pressure C6H12 stream at just above condensation temperature is cooled to below condensation temperature by passing through the colder regenerator core in the opposite direction, simultaneously heating the regenerator core back to the original temperature in preparation for the next quantity of C6H6 “coolant”. To perpetuate the process cyclically, the regenerator is outfitted with various valves and/or pistons, as described in Ser. No. 18/362,951. In No. Ser. 18/362,951, FIG. 1 through FIG. 4 illustrate a piston/cylinder means for exchanging heat between two constant pressure streams. In Ser. No. 18/362,951, FIGS. 5a and 5b, shown herein respectively as FIG. 5 and FIG. 6 herein, a non-piston/cylinder means is illustrated. Note from FIG. 6 and FIG. 7 that two regenerators with alternating cycles can be used to create a continuous fluid flow in both directions by cyclically switching the stream.

Per FIG. 1 and FIG. 2, at 2 Atm and approximately 550 K (990 R), the exothermic catalytic union of 1 mol of C6H6 (product) and 3 moles of H2 (product) creates an essentially 100% complete conversion to 1 mol of C6H12 (reactant) (see FIG. 1 and FIG. 4, point H1). Assuming a temperature of 400 K (720 R) exiting an EREC that compresses the C6H6 vapor from about 1.7 Atm and 372 K (670 R) to about 2 Atm, we can calculate the thermal energy required to preheat the C6H6 and H2 product from the information given above under “Essential quantities” as equal to:
1 mol C6H6 at 322 K and 1 Atm (point A) is pump pressurized to 322 K and 1.7 Atm. (FIG. 4, point D) to the vaporization point at 1.7 Atm of about 367 K (FIG. 4, point E). Liquid heat capacity=6.1 kJ.
C6H6 at 367 K and 1.7 Atm is vaporized. Vaporization requirement=33.9 kJ.
C6H6 at 367 K is raised to 372 K (point F). Vapor heat capacity=0.5 kJ.
EREC Win raises pressure to 2 Atm and temperature to 400 K (point G). Required force equals 0.5 Win.
An H2 compressor raises pressure for 3 moles of H2 from 1 Atm and 322 K (point A) to 2 Atm and about 400 K (point G)—see calculations below).
C6H6 at 400 K and 2 Atm is raised to 550 K (point H1). Molar vapor heat capacity=12.4 kJ.
H2 at 400 K and 2 Atm is raised to 550 K (point H1). Molar vapor heat capacity=13.0 kJ. H2 and C6H6 are converted to C6H12 at 550 K (point H1).

Following the conversion, the latent thermal energy in the C6H12 reactant exiting the exothermic reactor can potentially be used to preheat the C6H6 and/or H2 product entering the exothermic reactor. We can calculate the thermal energy produced by cooling the C6H12 reactant:
C6H12 at 550 K and 2 Atm to 400 K (point G). Molar vapor heat capacity=15.8 kJ. Per the vaporization line, C6H12 at 2 Atm will condense at about 378 K (680 R) (FIG. 4, point I).
C6H12 at 400 K and 2 Atm to 378 K (FIG. 4, point I). Molar vapor heat capacity=2.3 kJ
C6H12 at 378 K and 2 Atm (point I) to 322 K (point J). Molar liquid heat capacity=8.7 kJ.
C6H12 (liquid) at 322 K and 2 Atm is dropped by hydraulic motor to 322 K and 1 Atm (FIG. 4 point A).

### Conclusions

C6H12 vapor at 500 K and 2 Atm has [15.8-12.4=] 3.4 kJ more thermal energy than is required to raise the C6H6 vapor from 400 K to 550 K.
Total additional outside source heat required to heat the H2 from 400 K to 550 K equals the molar vapor heat capacity of the H2, or 13.0 kJ, minus the excess C6H12 thermal heat capacity between 550 K and 400 K, or 3.4 kJ, for a total of 9.6 kJ of outside source heat required.
Between 400 K and its condensation point at 378 K, C6H12 vapor has an additional 2.3 kJ of latent vapor heat capacity available.
Adding the 2.3 kJ available C6H12 excess vapor heat capacity and the 1.7 kJ C6H12 liquid heat capacity to the 32 kJ C6H12 molar condensation thermal capacity equals 36 kJ excess thermal capacity at 367 K, or 2.1 kJ over the 33.9 kJ required to vaporize the C6H6 at 1.7 Atm and 367 K.
Adding the available C6H12 excess thermal capacity to the remaining C6H12 molar liquid heat capacity of 7 kJ equals 0.9 kJ excess thermal capacity over the 6.1 kJ required to preheat the C6H6 at 1.7 Atm from 322 K to 367 K.

In addition to the 9.6 kJ of Hin required to preheat the 3 moles of H2 and the EREC Win, the H2 compressor will also require Win as calculated below.
1. It is assumed that C6H6 is made available at 1 Atm and 120 deg F (322 K, 580 R), or point A, where it is a liquid, and that the C6H6 liquid is then pump-pressurized to about 1.7 Atm (point D) at essentially constant temperature (322 K).
2. The 1.7 Atm C6H6 liquid is then raised in temperature at constant pressure to about 367 K (660 R), or point E, which is approximately equal to the vaporization point of C6H6. It is assumed that this is accomplished by counter-flowing condensed, hot liquid C6H12 at 2.0 Atm.
3. The 1.7 Atm C6H6 liquid is then further raised to about 372 K (670 R) at constant pressure, or point F, again assumed to be accomplished by counter-flowing vaporous and condensing C6H12 at 2.0 Atm, ideally completely vaporizing the C6H6.
4. The vaporous C6H6 at about 372 K is then compressed to 2 Atm (point G) in an EREC (see above). Per FIG. 3 and FIG. 4, that will raise the temperature to about 400 K (720 R).
5. The vaporous C6H6 at 400 K and 2 Atm will then be exhausted from the EREC compressor.
6. The vaporous C6H6 at 2.0 Atm and 400 K will then be raised at constant pressure to 550 K (990 R), or point H1, either through use some of the exothermic heat released in the following catalytic conversion, or through use of the C6H12 vapor exiting from the catalytic converter.
7. The 3 moles of H2 required for the exothermic reaction will simultaneously be compressed to the pressure of the catalytic reactor, in this case from 1 Atm to 2 Atm. TAssuming that the H2 compressor is a positive displacement compressor, per the CGLC, 3 moles of H2 at 1 Atm (point A) and 322 K (580 R) has a volume of 79.27 L. The intake of 1 Atm (14.7 psi) of H2 to a volume of 79.27 L (2.80 cu ft) equals 2.8 sq ft (403.2 sq in) over 1 ft of travel. Total force from the intake process at constant pressure thus equals 5,927 ft lbs or 8.0 kJ Wout.
8. Per the CGLC, compressing the 3 moles of H2 to 2.0 Atm (point G) will raise it to about 400 K (720 R, 260 deg F) and reduce volume to about 48.4 L, and the required force for compression equals 4.4 kJ Win.
9. The 3 moles of compressed H2 at 400 K and 2 Atm will then be exhausted from the compressor. We know the volume of the H2 is 48.4 L (1.71 cu ft). The force produced per stroke over 1 foot of travel equals 2 Atm or 29.4 psi times 80.9 sq in (1.71 sq ft) or 2,380 ft lbs or about 4.9 kJ Win. Total H2 compression required force thus equals the Win of compression plus the Win of exhaust minus the Wout of intake, or 1.3 kJ Win.
10. The H2 at 2 Atm and 400 K is then preheated to the exothermic temperature of the reactor or 550 K (point H1), requiring the addition of 13 kJ of thermal energy. One way to do this is to use some of the exothermic heat released in the preceding catalytic conversion. A second way is to use the C6H12 vapor exiting from the exothermic reactor to preheat the H2 rather than preheat the vaporous C6H6. Assuming the exhausting C6H12 reactant stream is used, C6H12 vapor between 550 K and and 400 K has [15.8−13.0=] 2.8 kJ more thermal energy than is required to raise the H2 from 400 K to 550 K. A third way is to use the 3.4 kJ of available vapor heat capacity between 550 K and 400 K, or 21.5% of the total available heat capacity in the hot C6H12 vapor, to preheat about 26% of the H2 to 550 K, and heat the remaining 74% with exothermic heat released in the preceding catalytic conversion, equal to about 9.6 kJ Hin.
11. At some point following the C6H6 exhausting from the EREC, the 2 Atm H2 and the C6H6 will be mixed together at the same temperature and pressure, for example at 550 K and 2 Atm (point H1).
12. The C6H6+3H2 product mix will then be passed through the exothermic catalytic reactor. A constant pressure and temperature conversion will then occur (point H1), converting C6H6+3H2 to C6H12 reactant. Per mol of C6H12 formed, that will produce 218.7 kJ/mol of thermal energy at 550 K. (At that point, the H2 will be chemically stored in a vaporous form, at a quarter of the previous total mol count, including the C6H6, of 4 moles, and may then be either reduced to a liquid state at ambient pressure and temperature or compressed and kept at high temperature for future use.)
13. A counterflow heat exchange to about 400 K (point G) will then take place between the vaporous reactant C6H12 stream exiting the reactor and either the product C6H6 vaporous product stream or the 3H2 gaseous product stream. Assuming the C6H12 is used to preheat the C6H6, about 3.4 kJ of excess thermal energy will remain in the vaporous C6H12 at 2.0 Atm and 400 K and is potentially available to use as a means of reducing the thermal preheating requirement of the 3 moles of H2.
14. The C6H12 vapor at 400 K and 2 Atm will now be used to vaporize the C6H6 liquid at 367 K. Per the vaporization line (FIG. 4, point I), C6H12 at 2 Atm boils/condenses at about 378 K. Cooling the C6H12 from 400K to 378 K will require/produce an additional 2.3 kJ of excess thermal energy. Condensation energy equals an additional 32 kJ. Liquid molar heat capacity between 378 K and 367 K equals an additional 1.7 kJ. Assuming 3.4 kJ were removed for H2 preheating, a total of [2.3+32+1.7=) 36 kJ towards the required thermal energy to vaporize 1 mol of C6H6, which equals about 33.9 kJ. Therefore, a net [36−33.9=] 2.1 kJ of excess thermal energy remains in the liquid C6H12 following full vaporization of the C6H6.
15. The C6H12 reactant stream, having been cooled to a liquid state, is then used to preheat the C6H6 liquid product stream, moving at constant pressure to 322 K (point J), as shown in FIG. 4. Since liquid C6H12 has 22.6 J/(mol K) more heat capacity than C6H6 liquid, the net heat capacity in 1 mol of liquid C6H12 dropping from 367 K towards 322 K equals 1.0 kJ/mol more liquid heat capacity than required to preheat 1 mol of liquid C6H6 from 322 K to 367 K, for a total of 3.1 kJ of excess thermal energy remaining in the C6H12 stream.
16. Finally, the C6H12 liquid stream at 322 K and 2 Atm may be used to power a hydraulic motor as it is reduced to a pressure of 1 Atm, shown as a constant temperature move in FIG. 4 (from point J to point A).

Total H2 compression Win plus EREC Win thus equals 1.8 kJ. Total Hin equals 9.6 kJ.

### Bi-Pressure Adiabatic Expansion Exothermic Half-Cycle

There is a second approach to building a bi-pressure exothermic half-cycle, termed a “bi-pressure adiabatic expansion exothermic half-cycle”, shown in FIG. 4 by the lines through the points A, D, E, F, G, L, H1 (or H2), M, N, O, B, A. Note that movement through points A, D, E, F, and G, are exactly the same as for the bi-pressure exothermic half-cycle described above. In this cycle, the vaporous C6H12 exiting the exothermic reactor is expanded to produce work. Note that the C6H12 can be superheated prior to expansion (not shown).

Pre-conversion, EREC and H2 compression Win and the thermal energy required to preheat the C6H6 and H2 product to the exothermic catalytic reaction temperature of 550 F is the same as calculated for the bi-pressure exothermic half-cycle.
mol C6H6 at 322 K and 1 Atm (point A) is pump pressurized to 322 K and 1.7 Atm (point D) to the vaporization point at 1.7 Atm of about 367 K (point E). Liquid heat capacity=6.1 kJ.
C6H6 at 367 K and 1.7 Atm is vaporized. Vaporization requirement=33.9 kJ.
C6H6 at 367 K is raised to 372 K (point F). Vapor heat capacity=0.5 kJ.
EREC raises pressure to 2 Atm and temperature to 400 K (point G). Per above, required force equals 0.5 kJ Win.
C6H6 at 400 K and 2 Atm (point G) is raised to 456 K (820 R) (point L). Vapor heat capacity=4.6 kJ.
C6H6 at 456 K and 2 Atm (point L) is raised to 550 K (point H1). Vapor heat capacity=7.8 kJ.
An H2 compressor raises pressure for 3 moles of H2 from 1 Atm and 322 K (point A) to 2 Atm and about 400 K (point G). From above, total required force for H2 compression equals 9.3 kJ Win.
H2 at 400 K and 2 Atm is raised to 550 K (point H1). Heat capacity=13.0 kJ. H2 and C6H6 are converted to C6H12 at 550 K (point H1).

Following the conversion to 100% C6H12 at 2 Atm and 550 K (point H1, or point H2 with a 90% conversion), an isobaric intake takes place. Assuming a positive displacement expander, we can estimate an isobaric intake of 1 mol of C6H12 vapor (calculated as CH4). Per the CGCL, 1mol of C6H12 at 2 Atm and 550 K has a volume of 22.6 L (0.8 cu ft). Along a 1 foot stroke, the piston would have an area of 0.80 sq ft or 115 sq in, and the force generated would equal 29.4 ft 1b/sq in or 3.4 kJ.

Per the CGLC, and using CH4 as a substitute for C6H12, Wout for the isobaric expansion to 1 Atm and 456 K (820 R) equals Wout of 2.24 kJ

The Win of exhaust is equal to a piston moving 38.4 L (1.36 cu ft) of C6H12 vapor at 1 Atm along a 1 foot stroke. The piston would have an area of 1.36 sq ft or 195 sq in, and the resistance would equal 14.7 1b/sq in or 2,866 ft lb or about 3.9 kJ Win.

Total expander net force generated equals (intake Wout plus the adiabatic Wout minus the isobaric exhaust Win) 1.74 kJ Wout.
Including EREC and H2 compressor Win equals an total force requirement per stroke of 8.1 kJ Win. The latent thermal energy in the C6H12 reactant exiting the expander can potentially be used to preheat the C6H6 and/or H2 product. Per the vaporization line (FIG. 4, point I), C6H12 at 1 Atm will condense at about 378 K (680 R). Again, we can calculate the thermal energy produced by cooling the C6H12 reactant:
550 K (point H1) to 456 K (point M) C6H12 vapor heat capacity=9.9 kJ.
456 K (point M) to 400 K (point N) C6H12 vapor heat capacity=5.9 kJ.
400 K (point N) to 367 K (point O) C6H12 vapor heat capacity=3.5 kJ.
367 K (point O) to 354 K (point B) C6H12 vapor heat capacity =1.4 kJ.
354 K C6H12 molar condensation capacity =32 kJ.
354 K (point B) to 322 K (point A) C6H12 liquid heat capacity=5.0 kJ.

### Conclusions

C6H12 vapor at 1 Atm between 456 K (point M) and 400 K (point N) has 5.3 kJ more thermal energy than is required to raise the C6H6 vapor at 2 Atm from 400 K to 456 K.
C6H6 vapor at 2 Atm between 456 K (point L) and 550 K (point H1) requires additional source heat equal to 7.75 kJ Hin.
Assuming preheating of the 3 moles of H2 at 2 Atm and 400 K (point G) uses the 5.3 kJ excess heat capacity in the C6H12 exhausting at 1 Atm and 550 K, the 3H2 still requires additional source heat equal to 7.7 kJ Hin to reach the target temperature of 550 K.
Per the above, to reach complete vaporization at 372 K (point F) the C6H6 vapor at 1.7 Atm and 367 K (point E) requires both heat of vaporization input of 33.9 kJ and vapor heat capacity input of 0.5 kJ. The 0.5 kJ C6H6 vapor heat capacity requirement may be more than satisfied by the vapor heat capacity remaining in the C6H12 between 400 K (point N) and 367 K (point O), yielding 3.0 kJ of C6H12 vapor heat capacity remaining.
Between 367 K (point E) and 354 K (not shown), C6H6 liquid at 1.7 Atm requires 1.8 kJ Hin. Between 367 K (point O) and 354 K (point B) for C6H12 at 1 Atm, an additional 1.7 kJ vapor heat capacity is available, or a total of 4.7 kJ, yielding a potential thermal excess of about 3 kJ Hout.
Between 354 K (not shown) and 322 K, C6H6 liquid at 1.7 Atm requires 4.3 kJ Hin. Between 354 K and 322 K C6H12 liquid at 1 Atm can yield 5 kJ Hout. Therefore, there is more than enough heat energy available in the C6H12 to preheat the C6H6 liquid at 1.7 Atm to its vaporization temperature.

Note: Steps 1 through 8 below are the same as for the “bi-pressure exothermic half-cycle” described above. In one typical example of a bi-pressure adiabatic expansion exothermic half-cycle, the vaporous C6H12 at 550 K and 2 Atm (point H1) is expanded to 1 Atm to create Wout (point M), lowering the pressure and temperature of the C6H12. Latent heat in the expanded C6H12 (point M) may then be used to preheat the vaporous C6H6 exiting the EREC from 400 K (point G) to about. FIG. 4 shows point L and point M at 456 K (820 R) as the temperature when the exchange of C6H12 latent heat begins passing to vaporous C6H6 or H2. The inference is that heat added to either C6H6 or H2 between point L at and point H1 at 550 K needs to come from source heat. The amount of thermal energy required to raise H2 from 456 K to 550 K is 8.1 kJ, while the amount required to raise C6H6 vapor the same amount equals 7.7 kJ. The required total amount of Hin at 550 K equals 15.9 kJ.
1. It is assumed that C6H6 is made available at 1 Atm and 120 deg F. (322 K, 580 R), or point A, where it is a liquid, and that the C6H6 liquid is then pump-pressurized to about 1.7 Atm (point D) at essentially constant temperature (322 K).
2. The 1.7 Atm C6H6 liquid is then raised in temperature at constant pressure to about 367 K (660 R), or point E, which is approximately equal to the vaporization point of C6H6. It is assumed that this is accomplished by counter-flowing condensed, hot liquid C6H12 at 2.0 Atm.
3. The 1.7 Atm C6H6 liquid is then further raised to about 372 K (670 R) at constant pressure, or point F, again assumed to be accomplished by counter-flowing vaporous and condensing C6H12 at 2.0 Atm, ideally completely vaporizing the C6H6.
4. The vaporous C6H6 at about 372 K is then compressed to 2 Atm (point G) in an EREC (see above). Per FIG. 3 and FIG. 4, that will raise the temperature to about 400 K (720 R).
5. The vaporous C6H6 at 400 K and 2 Atm will then be exhausted from the EREC compressor.
6. The vaporous C6H6 at 2.0 Atm and 400 K will then be raised at constant pressure to 550 K (990 R), or point H1, either through use some of the exothermic heat released in the following catalytic conversion, or through use of the C6H12 vapor exiting from the catalytic converter.
7. The 3 moles of H2 required for the exothermic reaction will simultaneously be compressed to the pressure of the catalytic reactor, in this case from 1 Atm to 2 Atm. Assuming that the H2 compressor is a positive displacement compressor, per the CGLC, 3 moles of H2 at 1 Atm (point A) and 120 deg F. (322 K, 580 R) has a volume of 79.27 L. Per the CGLC, compressing the 3 moles of H2 to 2.0 Atm (point G) will raise it to about 400 K (720 R, 260 deg F.) and reduce volume to about 48.4 L, and the required force for compression equals 4.4 kJ Win.
8. The 3 moles of compressed H2 at 400 K and 2 Atm will then be exhausted from the compressor. We know the volume of the H2 is 48.4 L (1.71 cu ft). The force produced per stroke over 1 foot of travel equals 2 Atm or 29.4 psi times 80.9 sq in (1.71 sq ft) or 2,380 ft lbs or about 4.9 kJ Win. Total H2 compression equals 9.3 kJ Win.
9. Assuming a positive displacement expander, we can estimate an isobaric intake of 1 mol of C6H12 vapor (calculated as CH4). Per the CGCL, the 1 mol of C6H12 at 2 Atm and 550 K is at a volume of 22.6 L (0.8 cu ft). The force generated per stroke over 1 foot of travel equals 2 Atm or 29.4 psi times 115 sq in (0.8 sq ft) or 3,381 ft lbs or about 4.6 kJ Wout.
10. Per the CGLC, and using CH4 as a substitute for C6H12, an adiabatic expansion from 2 Atm to 1 Atm increases volume to 38.4 L and drops the temperature to 468 K. The force generated by the isobaric expansion to 1 Atm and 456 K (820 R) equals 2.2 kJ Wout.
11. The Win of exhaust is equal to a piston moving 38.4 L (1.36 cu ft) of C6H12 vapor at 1Atm along a 1 foot stroke. The piston would have an area of 1.36 sq ft or 195 sq in, and the resistance would equal 14.7 lb/sq in or 2,866 ft lb or about 3.9 kJ Win.

Total expander net generated force equals (intake Wout plus the adiabatic Wout minus the isobaric exhaust Win) about 3 kJ Wout.
12. Cooling the C6H12 at 400 K to the C6H6 vaporization temperature at 1.7 Atm of 367 K requires the removal of 5.1 kJ. This can be used to offset a portion of the C6H6 evaporation thermal requirement, which equals 33.9 kJ, reducing that Hin requirement to about 29 kJ.
13. Finally, a large amount of energy remains in the C6H12 that can remove any thermal requirement to preheat C6H6 liquid to its evaporation temperature.
14. The total Hin required at 550 K is thus equal to 15.9 kJ, the total Hin required at 367 K equals 29 kJ, for a total required Hin of about 35 kJ. From above, net Wout of isobaric and adiabatic expansion of the C6H12 from 550 K to 456 K versus the H2 compression and EREC Win equals a net Win requirement of 5.8 kJ

### Mixed-Pressure Exothermic Half-Cycle

There is yet another way to building a basic exothermic half-cycle, termed a “mixed-pressure exothermic half-cycle”. In such a half-cycle, an EREC is used, not to pressurize the C6H6 vapor, but to pressurize the C6H12 vapor. A possible half-cycle is shown in FIG. 4 by the lines through the points A, B, C1 (or C2), O, P, E, D, A. This exothermic half-cycle can also be thought of as a hybrid of the mono-pressure and the bi-pressure exothermic half-cycles described above, since it utilizes an exothermic reaction at a latent pressure of 1 Atm but still uses a EREC for part of the cycle. Following the exothermic production of C6H12 reactant at 1 Atm, it is immediately exhausted into a counterflow heat exchanger and used to preheat the inflowing C6H6 vapor at 1 Atm up to the temperature of the exothermic reactor. When the thus-cooled C6H12 vapor at 1 Atm is close to the temperature at which it will condense into liquid, it is compressed by an EREC to a higher temperature and pressure, in this example to about 1.7 Atm. A higher pressure will permit the C6H12 stream to condense at a sufficiently higher temperature than the 1 Atm C6H6 stream's vaporization temperature to drive vaporization to completion.

Once exhausted from the EREC, the C6H12 vapor is cooled by heating the inflowing C6H6 liquid, first from ambient, then to near vapor point, then through the vapor point, then to the temperature of the C6H12 exiting the EREC.

As with a “mono-pressure exothermic half-cycle”, per FIG. 1, at 1 Atm and approximately 530 K (954 R), it is assumed that the catalytic union of 1 mol of C6H6 (product) and 3 moles of H2 (product) creates an essentially 100% complete conversion to 1 mol of C6H12 (reactant) (see FIG. 1 and FIG. 4, point C1). In addition, it is known that the exothermic catalytic reaction (at any temperature or pressure), produces 218.7 kJ/mol of thermal energy.

To create that reaction, the C6H6 and H2 will first need to be raised from 322 K to the exothermic temperature. While H2 gas only needs to be preheated, thus avoiding any Win of compression, C6H6 is a liquid at 322 K, and it must first be raised to the temperature of vaporization, then vaporized, then preheated. Assuming an exothermic reaction temperature of 530 K (point C1), we can calculate the thermal energy required to preheat the C6H6 and H2 product from the information given above under “Essential quantities” as equal to:
322 K to 354 K (point A to point B) total C6H6 molar liquid heat capacity=4.6 kJ.
354 K C6H6 molar vaporization requirement=33.9 kJ.
354 K to 530 K (point B to point C1) C6H6 molar vaporization requirement=14.5 kJ.
The total H2 molar vapor heat capacity required for preheating 3 moles of H2 from 322 K to 530 K (point A to point C1) equals a Hin of 18.0 kJ.

Following the exothermic conversion, the latent thermal energy in the C6H12 reactant exiting the exothermic reactor can potentially be used to preheat the C6H6 or H2 product. In this instance, however, the vaporous C6H12 exiting the exothermic reactor at 1 Atm will exchange heat until about 367 K (660 R) (point O), or in this example just prior to the C6H12 condensation point at 1 Atm (point B), insuring that the C6H12 is still in its fully vaporous state.

The pressure and thus the temperature will be increased by the EREC a small amount, for example an adiabatic compression to 1.7 Atm (point O), increasing the temperature from about 367 K to about 430 K (775 R) (point P). Per the CGLC, and using CH4, 1 mol of CH4 at 367 K and 1 Atm has a beginning volume of 30.1 L, and at 1.7 Atm has an ending volume of 20 L, a final temperature of 415 K (or about 430 K per FIG. 4, which will be used for the first-order calculation), and Win of about 1.3 kJ.

Estimating heat capacities for the C6H12 vapor:
530 K to 367 K (point C1 to point O) C6H12 molar vapor heat capacity=17.1 kJ
EREC adiabatic C6H12 vapor compression from 1 Atm and 367 K to 1.7 Atm and 430 K (point P). EREC force required equals 0.5 kJ Win.
Post-EREC: 430 K to 367 K (point P to point E) C6H12 at 1.7 Atm molar vapor heat capacity=3.5 kJ.
Total C6H12 at 1.7 Atm molar vapor heat capacity=20.6 kJ
367 K C6H12 molar condensation thermal capacity=32 kJ. 367 K to 322 K (point E to point D) total C6H12 at 1.7 Atm molar liquid heat capacity=7.0 kJ.
C6H12 @322 K and 1.7 Atm hydraulic expansion to 1 Atm (point A)

### Conclusions

The C6H12 molar vapor heat capacity equals 6.1 kJ more than is required to preheat the vaporized C6H6 from 354 K to 530 K.
The 32 kJ of condensation thermal energy plus the 6.1 kJ excess vapor heat capacity equals 4.2 kJ of excess C6H12 heat capacity over the 33.9 kJ required to vaporize the C6H6.
2.4 kJ/mol excess heat capacity in the C6H12 liquid over that required to heat the liquid C6H6 from 322 K to 367 K.
The total excess C6H12 heat capacity may be applied to helping to preheat the H2, reducing the total H2 thermal requirement between 322 K and 530 K to 9.5 kJ.
The liquid C6H12 remains at 1.7 Atm and 322 K, which represents energy that can be captured in a hydraulic motor, thus providing power that can then be supplied to pump the 1 Atm C6H6 and the 1 Atm H2. Total required force thus equals 0.5 Win.

### Basic Endothermic Half-Cycles

### Mono-Pressure Endothermic Half-Cycle

The simplest endothermic half-cycle would take place at constant pressure throughout. Such a “mono-pressure endothermic half-cycle” is shown in FIG. 4 by the lines through points A, B, Q1 (or Q2), B, A where the vaporization line at point B indicates that C6H12 at 1 Atm boils/condenses at about 356 K (640 R). As in the mono-pressure exothermic half-cycle discussed earlier, in this half-cycle, no compression work is required other than basic pumping work, since the pressure doesn't change.

Per FIG. 1, at 1 Atm and approximately 890 K (1,600 R), it is assumed that the endothermic catalytic reaction of 1 mol of C6H12 reactant creates an essentially 100% complete conversion to 1 mol of C6H6 and 3 moles of H2 product mix (point Q1), absorbing 218.7 kJ/mol of thermal energy. At about 810 K (1,458 R), a 90% complete conversion is created (point Q2), absorbing 218.7 kJ/mol of thermal energy, or 196.8 kJ of thermal energy for 0.9 moles of converted C6H12.

To create that reaction, the C6H12 at 1 Atm will first need to be raised from 322 K (point A) to the endothermic temperature (point Q1 or Q2). C6H12 is a liquid at 322 K, and it must first be raised to the temperature of vaporization, then vaporized, then preheated. Assuming an endothermic reaction temperature of 890 K (point Q1), we can calculate the thermal energy required to preheat the C6H12 reactant from the information given above under “Essential quantities” as equal to:
322 K (point A) to 354 K (point B) C6H12 molar liquid heat capacity=5.0 kJ.
354 K C6H12 molar condensation requirement=32 kJ
354 (point B) K to 890 K (point Q1) C6H12 molar vapor heat capacity=57.9 kJ

Following the conversion, the latent thermal energy in the C6H6 product exiting the exothermic reactor at 1 Atm can potentially be used to preheat the C6H12 reactant. Again, we can calculate the thermal energy in the C6H6 and H2 products:
890 K (point Q1) to 354 K (point B) C6H6 molar vapor heat capacity=44.2 kJ.
354 K C6H6 molar condensation requirement=33.9 kJ.
354 K (point B) to 322 K (point A) C6H6 molar liquid heat capacity=4.59 kJ.

Similarly, we can calculate the molar vapor heat capacity within the 3 moles of H2:
890 K (point Q) to 354 K (point B) H2 molar vapor heat capacity=46.3 kJ.
354 K (point B) to 322 K (point A) H2 molar vapor heat capacity=2.8 kJ.

### Conclusions

No Win is required except for the minimal work required to pump the liquid C6H12.
The total thermal energy in the C6H6+3H2 exhaust between 890 K and 354 K thus equals 90.5 kJ, or about 32.6 kJ or 36% more than is required to preheat the C6H12 reactant vapor.
As with the mono-pressure exothermic half-cycle, it is not practical to use the 1 Atm C6H6 condensation energy to vaporize the 1 Atm C6H12. As a result, to complete this particular endothermic half-cycle's vaporization requirement, it will be necessary to “borrow” from elsewhere the approximately 32 kJ Hin over 354 K required to vaporize 1 mol of C6H12 at 1 Atm.
All but 0.4 kJ of the 5 kJ required to preheat the C6H12 liquid to 354 K can be supplied by the condensed liquid C6H6.
Between 354 K and 322 K, there remains 2.8 kJ of vapor heat capacity available within the H2, and the total thermal energy available at 354 K equals 36.7 kJ.

Note that, as stated above, 32.6 kJ of the total thermal energy in the C6H6+3H2 exhaust between 890 K and 354 K is not required in order to preheat the C6H12 reactant vapor. As a means of making that potential energy useful, it is proposed to separate the product mix exiting the exothermic reactor into a 36% stream and a 64% stream. Since 890 K is high grade heat, it is further proposed that the 36% stream of product mix be used to efficiently power a heat engine, otherwise known as a “bottoming cycle engine”. Note that such a bottoming cycle engine has very high potential thermal efficiency, due to the high grade heat of the heat source. The 36% product stream thus represents potential high thermal efficiency net Wout for this simple endothermic half-cycle.

The available thermal energy within the 36% product stream can be calculated from the information given above under “Essential quantities”. Note that the C6H6 condensation energy is unavailable, since it is at a fixed temperature. Also note that, in a heat engine with a gaseous or vaporous working fluid, only an amount of C6H6 heat capacity that is equal to the molar vapor heat capacity is available from the exhausting liquid C6H6. The thermal energy available to a heat engine in the C6H6 product stream is therefore equal to:
890 K to 354 K 36% C6H6 molar vapor heat capacity=15.9 kJ.
354 K to 322 K 36% C6H6 molar liquid heat capacity=0.9 kJ.

Similarly, we can calculate the molar vapor heat capacity within the 3 moles of H2:
890 K to 354 K 36% H2 molar vapor heat capacity=16.7 kJ.
354 K to 322 K 36% H2 molar vapor heat capacity=1.0 kJ.
Total 36% available thermal energy between 890 K and 322 K=34.5 kJ

The Carnot theoretical efficiency for a heat engine is defined by “source temperature minus sink temperature divided by source temperature”. In this instance, that is equal to (890-322)/890, or a 64% theoretical conversion of heat into work. Thus, in addition to converting the C6H12 into C6H6+3H2 and “storing” 218.7 kJ of thermal energy, this system can also theoretically create about 22 kJ of net Wout at a thermal efficiency of 64%, with no appreciable pumping requirement and at the thermal cost of adding about 32 kJ of heat at about 354 K, which is almost certainly available in the final exhaust of the proposed bottoming cycle heat engine.

### Bi-Pressure Endothermic Half-Cycles

Per FIG. 1 and FIG. 2, at 2.0 Atm and approximately 945 K (1,700 R) (FIG. 4, point S1), an essentially 100% complete C6H6+3H2 product is created from the catalytic dissociation of 1 mol of C6H12 (reactant). In addition, the endothermic catalytic reaction (C1), requires 218.7 kJ/mol of thermal energy. (Note that a 90% complete reaction will take place at 2 Atm and about 865 K (1,560 R) and will require 196.8 kJ/mol of reactant in endothermically absorbed thermal energy.)

Bi-pressure endothermic half-cycles are geared towards generating net Wout via expansion of higher pressure product. Three general approaches to creating work with an endothermic half-cycle are proposed. In the first approach, termed a “bi-pressure partial expansion endothermic half-cycle”, an estimated 62% portion (as will be shown) of the product mix exiting the reactor at reactor pressure is used to preheat the reactant from point G to the reactor temperature (point S1). Note the resemblance of the 62% portion to the 64% portion in the “Mono-pressure endothermic half-cycle” described earlier, and that, for the 62% portion, there is also no expansion process. In a low pressure example, the 62% portion follows the lines in FIG. 4 passing through points A, D, E, F, G, S1 (or S2), G, I, J, A. The remaining 38% portion of product mix at S1 (or S2) is expanded directly after exhausting from the endothermic reactor (assuming no superheating), following lines passing through points A, D, E, F, G, R, S1, T, N, B, A. In this example, following expansion, the 38% portion between point T and point B to 1 Atm (point T) has relatively high temperature thermal energy available for other uses in the exhaust, such as for powering a bottoming cycle engine. Note the resemblance to the “bi-pressure adiabatic expansion exothermic half-cycle” described earlier. Note further that the exhaust from such a bottoming cycle engine may itself provide adequate thermal energy at a high enough temperature to complete the vaporization of a following charge of C6H12 liquid, thus obviating any need for additional source heat for C6H12 vaporization purposes.

In a second approach to using the remaining 38% of product mix exiting the endothermic reaction chamber, the stream is not expanded but is used as a source of high temperature heat for powering some version of a an external “bottoming cycle engine”, thus indirectly generating work out. One interesting result of that approach is to essentially “generate” a pressurized gas, for example H2, at the endothermic reactor pressure.

In the third approach to constructing a bi-pressure endothermic half-cycle, termed a “bi-pressure total expansion endothermic half-cycle”, Wout is created by adiabatically expanding the total amount of product mix exiting the endothermic reactor. A low pressure example of such a half-cycle is defined by the lines shown in FIG. 4 that pass through points A, D, E, F, G, R, S1 (or S2), T, N, B, A. A higher pressure variant of this half-cycle will be analyzed below. Note that the product exiting the endothermic reactor may be either expanded directly or after being superheated (superheat not shown). Note further that the inflowing C6H12 vapor between point G and point Ris preheated by the exhausting product mix of C6H6 and H2 flowing from point T to point N. This “exhaust gas preheating” reduces the amount of source heat that needs to be added between point R and point S1, increasing potential thermal efficiency.

### Bi-Pressure Partial Expansion Endothermic Half-Cycles

In a “bi-pressure partial expansion endothermic half-cycle”, 62% of the product mix exiting the endothermic reactor (point S1) is separated out and used to preheat inflowing C6H12 vapor. In this variant, the remaining 38% of the product mix may be expanded to create work directly after exiting the endothermic reactor. Note that, as mentioned earlier, useful latent heat will remain in the 38% exhausting from the expander.

In this variant, as in the similar bi-pressure endothermic half cycles, liquid C6H12 will be pump-pressurized, in this example to 1.7 Atm, heated, and vaporized. The vaporous C6H12 will then be compressed from 1.7 Atm to 2.0 Atm in an Endothermic Reactor Exhaust Compressor (ENREC), as proposed and disclosed in No. 18/362,951, raising the temperature to about 400 K (725 R) (point G). (Note: By using an ENREC to moderately pressurize the vaporized C6H12, the C6H6 condensation temperature becomes usable as a means of helping vaporize the C6H12 liquid.)

After exiting the ENREC at about 400 K, the C6H12 is raised to the temperature of the endothermic reactor, or approximately 945 K. Following preheating of the C6H12 pressurized reactant (point G to point S1), a portion of the separated 62% quantity of pressurized product gas, in this case H2 that, between point I and point J, has been separated from the liquified C6H6, can then be “rewarmed” by the portion of the product mix not used to preheat pressurized reactant, be reheated back to the temperature of the endothermic reactor or superheated to an even higher temperature (not shown), and then be expanded to produce Wout.

As above, we can calculate the thermal energy states for the 100% C6H12:
1 mol C6H12 at 322 K and 1 Atm (point A) is pump pressurized to 322 K and 1.7 Atm (point D)
The C6H12 liquid at 322 K is raised to the vaporization point at 1.7 Atm of about 367 K (point E). Liquid heat capacity=7.0 kJ.
C6H12 at 367 K and 1.7 Atm (point E) is vaporized. Vaporization requirement=32 kJ.
C6H12 at 367 K and 1.7 Atm (point E) is raised to 372 K (point F). Vapor heat capacity=0.53 kJ.
EREC raises pressure to 2 Atm and temperature to 400 K (point G). As computed for C6H6 earlier, required compression force equals 0.5 kJ Win.
6H12 at 400 K and 2 Atm (point G) is raised to 945 K (point S1). Vapor heat capacity=57.23 kJ (57.76 total).

Following the conversion, 62% of the latent thermal energy in the C6H6 and H2 product mix (0.62 mol C6H6 and 1.86 moles H2) exiting the exothermic reactor at 2 Atm can potentially be used to preheat the C6H12 reactant. Again, we can calculate the thermal energy in the C6H6 and H2 products at 2 Atm and various end temperatures:
945 K (point S1) to 378 K (680 R) (point I) 0.62 mol C6H6 vapor heat capacity=28.92 kJ
378 K (point I) C6H6 0.62 mol condensation thermal output=21.0 kJ (65.7% of total requirement).
378 K (point I) to 322 K (point J) 0.62 mol C6H6 liquid heat capacity=4.69 kJ.

Similarly, we can calculate the molar vapor heat capacity within the 3 moles of H2:
945 K (point S1) to 378 K (point I) 1.86 moles H2 heat capacity=30.41 kJ.
378 K (point I) to 322 K (point J) 1.86 moles H2 heat capacity=3.00 kJ.

Total between temperature ranges for 0.62 mol C6H6 and 1.86 moles H2:
945 K (point S1) to 378 K (point I) C6H6 and H2 heat capacity=59.3 (103% of total requirement)
378 K (point I) to 322 K (point J) C6H6 and H2 heat capacity=7.69 kJ (110% of total requirement)

### Conclusions

The 62% quantity of exhausting product mix at 2 Atm and 945 K has 103% of the required vapor heat capacity to preheat the inflowing reactant at 1.7 Atm and 367 K to 372 K and from 400 K to the endothermic reaction temperature of 945 K.
The 62% quantity of exhausting liquid C6H6 product constituent at 2 Atm and 378 K has 67% of the required liquid heat content to preheat the inflowing liquid reactant from 322 K to 367 K.
the 62% quantity of exhausting gaseous H2 product constituent at 2 Atm and 378 K has 69%% of the required heat capacity to preheat the inflow liquid reactant from 322 K to 367 K.
The combined exhausting liquid C6H6 product constituent and H2 product constituent therefore have 136% of the required heat content to preheat the inflowing liquid reactant from 322 K to 367 K.
Total force required equals 0.5 kJ Win. Excluding thermal energy captured thermochemically, total excess Hin required equals the thermal energy at 367 K to convert C6H12 liquid into C6H12 vapor, or 11 kJ Hin.
1. It is assumed that C6H12 produced earlier is made available at 1 Atm and 120 deg F (322 K, 580 R) (point A), where it is a liquid, and that the C6H12 liquid is then pump-pressurized to about 1.7 Atm (point D) at essentially constant temperature.
2. The 1.7 Atm C6H12 liquid reactant is then raised in temperature at constant pressure to 367 K (660 R) (point E), where it begins vaporizing, by counter-flowing against the exhausting 62% product mix of condensed C6H6 and H2 at 2 Atm and 378 K.
3. The reactant is then vaporized at constant pressure, assumed to happen at exactly 367 K. About 67% of the heat required for this vaporization may come from the condensation of the C6H6 constituent of the product mix at about 378 K. In addition, some potential heat below the 378 K condensing point of C6H6 will be available in the 68% portion of the product mix to possibly aid in the vaporizing of the liquid C6H12.
4. At 378 K (point F), the inflowing C6H12 reactant at 1.7 Atm is assumed to be fully vaporized, and the exhausting liquid C6H6 constituent of the product mix at 2 Atm is assumed to be fully condensed at 367 K (not shown). The vaporous C6H12 reactant would then be compressed to 2.0 Atm in an ENREC, raising the temperature to about 400 K (725 R) (point G). Note that the ENREC is essentially a match for the EREC used earlier for lightly compressing vaporous C6H6. Therefore, required force approximately equals the required force found above for the EREC, or about 0.5 kJ Win.
5. The vaporous C6H12 at 2.0 Atm and 400 K will then be raised at constant pressure to 945 K (point S1), a temperature difference of 545 K, by exchanging heat with 62% of the C6H6+3H2 exiting the endothermic reactor at that temperature.
6. At this point there are two possible means to create net Wout from the 0.38 moles of C6H6 and 1.14 moles of H2 product at 945 K and 2 Atm: (A) Expand the product adiabatically, isobarically, isothermally, or some combination thereof to create Wout; or (B) use the product mix as a means of supplying thermal energy to an external heat engine or “bottoming cycle” engine. Both will be generally examined, and will assume use of a positive displacement expander. For a first order analysis, the CGLC will be used and CH4 will represent the vaporous states of C6H6 and C6H12.

A. Assuming an adiabatic expansion of the 0.38 moles of product mix at the pressure and temperature of the endothermic reactor, the lines defining the cycle would pass through points A, D, E, F, G, R, S1, T, N, B, A. Note that this cycle is very similar to the “bi-pressure adiabatic expansion exothermic half-cycle” discussed earlier. Since the first portion of this cycle is shown directly above, the remaining steps can be shown by following the lines from point S1 through points T, B, A.:
(1) Per the CGLC, for 4 moles at 945 K and 2 Atm (29.4 psi), initial volume equals 155 L (point A1). The force of intake thus equals an isobaric expansion of 155 L (5.47 cu ft,) or 29.4 psi times 827 sq in (5.62 sq ft) over 1 foot of travel or 24,313 ft lbs or about 33.0 kJ Wout. For 38% of the product mix, force produced thus equals 12.5 kJ Wout.
(2) Per the CGLC, an adiabatic expansion to 1 Atm equals a final volume of 254 L, a final temperature of 774 K (1,394 R) and a force of expansion of 14.0 kJ Wout (point T). For 38% of the product mix, force produced thus equals 5.32 kJ Wout.
(3) The force required for exhaust equals an isobaric expulsion of 254 L (8.97 cu ft,) or 14.7 psi times 1,292 sq in (8.97 sq ft) over 1 foot of travel or 19,000 ft lbs or about 25.8 kJ Win (point T). For 38% of the product mix, force produced thus equals 9.80 kJ Wout.
(4) Total generated force for 1 mol of C6H6 and 3 moles of H2 thus equals 21.2 kJ times 0.38 minus the 0.5 kJ for the ENREC equals about 7.5 kJ net Wout (point T).
(5) Total heat at 774 K remaining in the 38% portion of the product mix equals 26.8 kJ between 774 K and 356 K (point B) and 2.9 kJ between 356 K and 322 K (point A), or 29.7 kJ Hout.
(6) Total required source heat equals the heat required at 367 K to convert C6H12 liquid into C6H12 vapor, or 11 kJ Hin.

B. One variant of this cycle can use the pressurized H2 produced by the 62% portion of the product mix used to preheat the C6H12 reactant. In essence, that pressurized H2 can become the working fluid for a “bottoming cycle” heat engine. The total heat content of the 38% portion is thus available to preheat the pressurized H2 from the 62% portion of the half-cycle, or in this instance the 1.86 moles of H2 at 2 Atm at the 378 K condensation temperature of the C6H6 product component. This particular “bottoming cycle” thus begins at point J or point I and follows the lines through points J or I, R, S1 (or S2), T, A. In this instance the bottoming cycle will begin at point I:
(1) 1.86 moles of H2 at 378 K and 2 Atm (29.4 psi) (point I), initial volume equals 28.85 L.
(2) Per CGLC, available C6H6 and H2 heat capacity in the 38% product mix portion between 945 K (point S1) to 378 K (point I) equals 28.8 kJ Hout. Per the CGLC, an isobaric expansion of 1.86 moles of H2 at 2 Atm from 378 K to 945 K would require 21.6 kJ Hin and increase volume to 72.13 L, or a net of 7.2 kJ Hout.
(3) The force of intake equals an isobaric expansion of 72.13 L (2.55 cu ft,) or 29.4 psi times 367 sq in (2.55 sq ft) over 1 foot of travel or 10,790 ft lbs or about 14.6 kJ Wout.
(4) Per the CGLC, an adiabatic expansion to 1 Atm equals a final volume of 118 L, a final temperature of 774 K and a force of expansion of 6.5 kJ Wout.
(5) The force required for exhaust equals an isobaric expulsion of 118 L (4.17 cu ft,) or 14.7 psi times 600 sq in (4.17 sq ft) over 1 foot of travel or 8,820 ft lbs or about 12 kJ Win.
(6) Total Wout for 1.86 moles of H2 minus the 0.5 kJ for the ENREC equals about 8.6 kJ net Wout.
(7) Total heat remaining in the 38% portion of the 1.86 moles of H2 between 774 K (point T) and 322 K (point A), equals 24.2 kJ Hout.
(8) Total net excess thermal energy at between 945 K and 744 K equals 31.4 kJ. Note that this strongly suggests that the pressure of the simple bi-pressure endothermic half-cycle should be increased, which will be explored below.
(9) Total required source heat equals the heat required at 367 K to convert C6H12 liquid into C6H12 vapor, or 11 kJ Hin.

### Bi-Pressure Total Expansion Endothermic Half-Cycle

An example of a bi-pressure total expansion endothermic half-cycle heat engine producing useful work out is shown in FIG. 4 by the lines through the points A, AA, AB, AC, AD2 (AD1 is off the scale), AE, AF, B, A. Note that, in this example, an ENREC is not shown being used. Also note that, since the peak temperature at AD1, signifying a 99% conversion, is off the chart, it is difficult to plot the exact point where an adiabatic expansion would be placed. Therefore, calculations will be based on AD2, signifying a 90% conversion, since the exact point where that adiabatic expansion would be placed can be shown.
1. In the possible half-cycle shown in FIG. 4, 1 mol of liquid C6H12 reactant at ambient pressure and temperature (point A) is pumped to 5.44 Atm at constant temperature of 322 K (point AA), requiring minimal Win.
2. The 1 mol of C6H12 liquid reactant is then isobarically raised in temperature to the vaporization temperature of about 422 K (760 R), requiring 15.6 kJ Hin (point AB).
3. The liquid reactant is then fully vaporized at constant pressure, raising the temperature to about 430 K (774 R), requiring 16.8 kJ Hin. Per the CGLC, volume equals 6.5 L (point not shown).
4. The vaporous reactant is then raised to about 667 K (1,200 R), requiring 25.7 kJ Hin from exhausting product mix. Per the CGLC, volume equals 10.1 L (point AC).
5. The vaporous reactant is then raised to about 944 K (1,700 R), requiring 99 kJ Hin. Per the CGLC, volume equals 14.2 L (point AD2), Hin equals 18.3 kJ. Note that this is source heat, for example from concentrated solar energy.
6. The vaporous reactant is then passed through the endothermic catalytic reactor, absorbing 196.8 kJ of thermal energy at 944 K (1,700 R), thereby essentially converting 90% of the 1 mol of C6H12 reactant into 0.9 moles of C6H6, 0.1 moles of C6H12, and 2.7 moles of H2 product mix (point AD2). Note that this conversion occurs at both constant temperature and constant pressure. Also note that the volume increases from 1 mol to 3.7 moles (not shown but inferred in FIG. 4). Per the CGLC, volume just following endothermic conversion of 1 mol of C6H12 equals 52.7 L and Hin equals 68.7 kJ.
7. The product mix is then taken into a positive expander at constant pressure (point AD2). Per the CGLC, for 3.7 moles at 944 K and 5.44 Atm (80 psi), volume equals 52.7 L. The force of intake thus equals an isobaric expansion of 52.7 L (1.86 cu ft,) or 80 psi times 268 sq in (1.86 sq ft) over 1 foot of travel or 21,440 ft lbs or about 29.1 kJ Wout per stroke.
8. The product mix is then adiabatically expanded from 4.4 Atm and 944 K to 1 Atm and about 667 K (1,200 R) (point AE). Per the CGLC, volume equals 193.1 L and force of expansion equals 31.1 kJ Wout per stroke.
9. The product mix is then exhausted from the expander at 1 Atm (point AE). The force of isobaric exhaust thus equals an isobaric exhaust of 193.1 L (6.82 cu ft,) or 14.7 psi times 982 sq in (6.82 sq ft) over 1 foot of travel or 14,435 ft lbs or about 19.6 kJ Win per stroke. Net expander force per stroke generated therefore equals 40.6 kJ Wout per stroke.
10. The exhausted C6H6+C6H12+H2 product mix at 1 Atm and 667 is then used to preheat the inflowing vaporous C6H12 reactant at 4.4 Atm from 430 K (point AF) to 667 K. The 0.9 moles of vaporous C6H6 heat capacity between 667 K and 430 K equals 17.6 kJ Hout. The 0.1 moles of vaporous C6H12 heat capacity between 667 K and 430 K equals 2.49 kJ Hout. The 2.7 moles of H2 heat capacity between 667 K and 430 K equals 18.5 kJ Hout. Total product mix heat capacity between 667 K and 430 K thus equals 38.6 kJ.
11. The product mix is then used to vaporize the reactant at 422 K (point AF). The 0.9 moles of vaporous C6H6 heat capacity between 430 K and 422 K equals 0.59 kJ Hout. The 0.1 moles of vaporous C6H12 heat capacity between 430 K and 422 K equals 0.08 kJ Hout. The 2.7 moles of H2 heat capacity between 430 K and 422 K equals 0.62 kJ Hout. Total product mix heat capacity between 430 K and 422 K thus equals 1.3 kJ. With the remnant 38.6 kJ in the product mix, the total thermal energy available to vaporize the C6H12 equals 39.9 kJ. With a standard heat of vaporization of 32 kJ/mol, the vaporous heat capacity remaining in the product mix drops to 8 kJ Hout.
12. C6H6 at 1 Atm boils/condenses at about 356 K (640 R) (point B). Between 422 (point AF) and 356 (point B) or 66 K, the 0.9 moles of vaporous C6H6 heat capacity equals 4.90 kJ Hout. The 0.1 moles of vaporous C6H12 heat capacity equals 0.54 kJ Hout. The 2.7 moles of H2 heat capacity between 667 K and 430 K equals 5.14 kJ Hout. Total product mix heat capacity between 422 K and 356 K thus equals 10.6 kJ. The product mix is then used to preheat the liquid reactant at 4.4 Atm from 322 K to 422 K (point AA). With the vaporous 8 kJ heat capacity remaining in the product mix, total available thermal energy in the product mix equals 18.6 kJ. At a liquid molar heat capacity of 156 J/(mol K), and a temperature difference of 66 K, the required thermal input to the liquid H2 equals 10.3 kJ, leaving 8.6 kJ excess vapor heat capacity in the product mix.
13. The product mix is then cooled to 322 K, separating the C6H6+C6H12 liquids from the H2 gas, ending the half-cycle (point A).

### B/E Chemical Pump Refrigeration Half-Cycle

In a second application of the “bi-pressure partial expansion endothermic half-cycle”, it is important to note that, between point I and point J, H2 gas at 2 Atm has automatically been separated from the now-liquid C6H6 product constituent. That permits an alternative usefulness for this half-cycle. It is perfectly feasible to now cool the H2 gas to ambient temperature, in this instance taken as 322 K (580 R, 49 deg C., 120 deg F.). The separated and pressurized product gas (in this case H2) can then be expanded to both create additional Wout (between point J and point K) and to create gas at a temperature below ambient. Meanwhile, the exhaust of the portion of the product mix not used to preheat pressurized reactant (from point T to point B) can still be used to preheat the working fluid of a bottoming cycle engine, whose working fluid can then be superheated back to the temperature of the endothermic reactor or beyond, then be expanded to produce additional Wout. Such a cycle is called a “B/E Chemical Pump Refrigeration half-cycle”

In a B/E Cycle using a catalytically-enhanced cyclical paraffin/olefin reaction such as the C6H12<->C6H6+3H2 reaction, H2 can be considered cyclically and thermochemically stored when heat is released and released when heat is stored. Since the release of H2 occurs when heat is chemically taken in, that is, when the chemical reaction is endothermic, thermal energy is added at a high temperature. Conversely, since the H2 storage occurs when the chemically stored heat is taken out, that is, when the chemical reaction is lower, thermal energy is ejected at a lower temperature. This arrangement is advantageous for use in a B/E Cycle heat engine, since thermal efficiency is impacted positively by high pre-expansion temperatures and low post-expansion temperatures.

However, there are other advantages to this cycle, particularly when viewed as a combination of two half-cycles. In a B/E Chemical Pump Refrigeration endothermic half-cycle (B/E CPR half-cycle), some of the latent heat within the product mix exhausting from the endothermic reactor is used to preheat the reactant before it enters the endothermic reactor. As has been shown, this greatly limits or even eliminates the source heat required to preheat the reactant. When part of the product mix is high pressure H2 held at constant pressure, this heat exchange process has the obvious effect of cooling the H2. However, what is not obvious is that, once cooled efficiently to a low temperature at constant pressure, the H2 may be adiabatically expanded from that low temperature to both produce both work and lower temperature H2. If the temperature of the H2 is ambient prior to expansion, then the expansion will drop the H2 temperature below ambient, allowing the H2 to be used as a refrigerant. Following refrigeration by the H2 of a substance or mechanism that it is desired to cool, the lower pressure warmed H2 can then be “re-stored” as C6H12, thus completing the cycle while (1) avoiding the need to store the low pressure H2 as a gas and (2) returning the previously stored thermal energy for other uses, albeit at a lower temperature than when it was stored. In that way, it becomes a different kind of full B/E Cycle.

A simple B/E CPR half-cycle can follow steps 1 through 7 of the process described above for the “bi-pressure endothermic half-cycle”, and following the lines through the points A, D, E, F, G, Q1 (or Q2), I, J, A, as shown in FIG. 4:
1. It is assumed that C6H12 produced earlier is made available at 1 Atm and 120 deg F. (322 K, 580 R) (point A), where it is a liquid, and the C6H12 liquid is then pump-pressurized to about 1.7 Atm (point D) at essentially constant temperature.
2. The 1.7 Atm C6H12 liquid is then raised in temperature to 367 K (660 R) (point E), where it begins vaporizing, and then to point F (380 K, 680 R), where it is assumed to be fully vaporized, by counter-flowing against condensing C6H6 at 2 Atm. Per FIG. 4, C6H6 at 2 Atm begins condensing at about 380 K (680 R), and is assumed to be fully condensed at 367 K (660 R). The net liquid heat capacity in 1 mol of liquid C6H6 between 380 K and 322 K equals 7.8 kJ. The net liquid heat capacity in 1 mol of liquid C6H12 between 367 K and 322 K equals 7.0 kJ. Thus, there is approximately 1 kJ/mol more liquid heat capacity in the liquid C6H6 than required to preheat 1 mol of liquid C6H12 from 322 K to 367 K. Note that, while vapor C6H12 still requires about 1.5 kJ/mol of vapor heat capacity to be raised from 353.2 K to 367 K, liquid C6H12 requires 1.9 kJ/mol less vaporization thermal energy than vaporous C6H6 possesses as condensation thermal energy, and that this condensation thermal energy is available at about 380 K.
3. The vaporous C6H12 would then be compressed to 2.0 Atm in an Endothermic Reactor Exhaust Compressor (ENREC), as proposed and disclosed in Ser. No. 18/362,951, raising the temperature to about 400 K (725 R) (point G). By using an ENREC to moderately pressurize the vaporized C6H12, the C6H6 the C6H6 condensation temperature becomes usable as a means of vaporizing the C6H12 liquid. The Win approximately equals the Win found above for an EREC, or about 2 kJ.
4. The vaporous C6H12 at 2.0 Atm and 400 K will then be raised at constant pressure to 945 K (point S1), a temperature difference of *545* K, by exchanging heat with 62% of the C6H6+3H2 exiting the endothermic reactor at that temperature, as will be shown. 1 mol of vaporous C6H12 heated a difference of *545* K equals *57.2* kJ/mol. 1 mol of vaporous C6H6 cooled a difference of *545* K equals 44.7 kJ/mol. 3 moles of H2 cooled a difference of 552 K equals 46.9 kJ of thermal energy, or a total of 91.6 kJ for the product mix. Thus, only 62% of the vaporous C6H6+3H2 product mix exiting is required for preheating the C6H12, and, assuming separation into two streams immediately following exhaust from the endothermic reactor, 38% or about 34.7 kJ/mol of thermal energy over the *545* K difference is available for other uses.
5. The 62% and 38% streams of vaporous C6H6+3H2 mix at 400 K will be recombined to supply their total amount of condensation thermal energy to the vaporization of the 100% C6H12 stream (point I). As noted above, C6H6 will have condensed out between 400 K and about 380 K, separating the C6H6 and the H2. Note that this will occur at a constant pressure, in this case at 2 Atm. Per the CGLC as shown above, 3 moles of H2 at 2.0 Atm and about 400 K have a volume of about 48.4 L. 3 moles of H2 has a heat capacity of 86.5 J per degree K. The amount of thermal energy in 36% of the product mix exiting the 100% conversion endothermic reactor at 2 Atm between 945 K and 400 K is equal to the temperature difference or 545 K times the combined vapor heat capacity per degree K (about 169 J/K) or 92.0 kJ times 0.38 or 35 kJ. Dividing by the heat capacity of 3 moles of H2 equals a change in temperature of 40 K, increasing the H2 at 2 Atm and 400 K to about 800 K. It can be assumed that, since the source temperature for the endothermic reactor must equal at least 945 K, that the 3H2 can be “superheated” to that temperature, or a temperature difference of 145 K, thus requiring the absorption of 12.5 kJ of source heat. This represents a constant pressure expansion. Per the CGLC, an isobaric expansion from 400 K to 945 K, volume would equal 116.3 L and Wout would equal 13.6 kJ.
6. The H2, having been separated from the C6H6, will be cooled to ambient (point J), possibly by helping warm the liquid C6H12 from ambient.
7. The H2 would then be expanded adiabatically to 1 Atm (point K). Per the CGLC, expanding 3 moles of H2 from 2.0 Atm to 1.0 Atm would increase the volume to 190.5 L, decrease the temperature to 774 K (500 deg C., 1,393 R, 933.5 deg F.), and simultaneously create 10.5 kJ of Wout. Total Wout for this cycle equals the Wout of the isobaric and adiabatic expansion or 24.1 kJ minus the Win of the ENREC or about 22 kJ per half-cycle.
8. Lastly, the H2 is used to cool something, returning it to point A.

Note the similarity of the B/E CPR half-cycle to the much simpler “bi-pressure partial expansion endothermic half-cycle”, variant B, described above. In that case, the expansion occurred following the endothermic reaction, and the primary function of the expansion was to create Wout. In the B/E CPR half-cycle, the expansion occurs after the H2 gas has been cooled to ambient, and the primary function of the expansion is to create refrigeration. Also, note that the combined vapor heat capacity in the exhaust of 3 moles of H2 between 400 K and 774 K would equal 32 kJ. This strongly suggests that the pressure of the simple bi-pressure endothermic half-cycle should be increased, which will be explored below.

FIG. 4 illustrates a B/E CPR half-cycle, as will be shown, that operates at the critical temperature and pressure for C6H12, estimated at about 39 Atm and 578 K (1040 R). One possible B/E CPR half-cycle follows the line connecting the points A, U, V, W, X1 (or X2), W, U, Y (or Z), A. (Note: The difference between the lines connecting points U, Y, and A and connecting points U, Z, and A, is that the first connects points Y and A via an isobaric or constant pressure line, while the second connects point Z and A via an isochoric or constant volume line.) It is assumed in FIG. 4 that an ENREC compression to about 40 Atm is sufficient to convert all the C6H12 into vapor, from which state it may be superheated to the required endothermic reactor temperature, shown in FIG. 1 and FIG. 2, of about 1,400 K (2,520 R) for a 99% conversion (point X1) and 1,230 K (1,754 R) for a 90% conversion (point X2). Note that these temperatures, as indicated by an arrow pointing towards points X1 and X2, are off the chart in FIG. 4.
1. It is assumed that 1 mol of C6H12 reactant produced earlier is made available at 1 Atm and 120 deg F. (322 K, 580 R), or point A, where it is a liquid, and the C6H12 liquid is then pump-pressurized to about 39 Atm (point U) at essentially constant temperature.
2. The 1 mol C6H12 liquid at 1 Atm and 322 K is then raised in temperature at constant pressure to 578 K (1,040 R) (point V), where it begins to vaporize. This temperature increase will largely be accomplished by using the net liquid heat capacity of 40 Atm C6H6 following its condensation, as will be shown. The net liquid heat capacity in 1 mol of liquid C6H6 between 322 K and 585 K equals 35.5 kJ. The net liquid heat capacity in 1 mol of liquid C6H12 between 322 K and 578 K equals 40.0 kJ. Thus, there is approximately 4.5 kJ less liquid heat capacity in 1 mol of C6H6 between 322 K and 585 K than required to preheat 1 mol of liquid C6H12 from 322 K to 578 K.
3. The vaporizing C6H12 will then be raised to about 583 K (1050 R), (point not shown), where it is assumed to be fully vaporized, by counter-flowing against C6H6 at 40 Atm. To vaporize C6H12, approximately 32 kJ of thermal energy will be required. Per FIG. 4, 1 mol of C6H6 at 40 Atm begins condensing at about 585 K (1,053 R) and is assumed to be fully condensed at 578 K (point not shown). C6H6 has a standard heat of condensation of 33.9 kJ. Thus, there is a net condensation heat of 1.9 kJ available in the condensing C6H6 over that required to vaporize the C6H12.
4. The vaporous C6H12 would then be compressed to 40 Atm in an ENREC, raising the temperature to about 585 K (1,053 R) (point W). By using an ENREC to moderately pressurize the vaporized C6H12, the C6H6+3H2 mix exiting the endothermic reactor (1) achieves a higher pressure and a higher thermal input temperature, improving theoretical heat engine thermal efficiency, and (2) the C6H6 condensation temperature becomes usable as a means of vaporizing the C6H12 liquid. As calculated earlier, for 1 mol of vaporized C6H6 or C6H12, the force of compression required will equal about 0.5 kJ Win.
5. Per FIG. 1, the vaporous C6H12 at 40 Atm and 585 K will then be raised at constant pressure to about 1,400 K (2,520 R) (point X1), or a temperature difference of 815 K, by exchanging heat with some of the C6H6+3H2 exiting the endothermic reactor at that temperature. 1 mol of vaporous C6H12 heated a difference of 815 K equals a vaporous heat capacity of 85.6 kJ. 1 mol of vaporous C6H6 cooled a difference of 815 K equals a vaporous heat capacity of 67.2 kJ/mol, and 3 moles of H2 cooled a difference of 815 K equals a heat capacity of 70.5 kJ of thermal energy, or a product mix vaporous heat capacity total of 138 kJ. Thus, assuming separation into two streams immediately following exhaust from the endothermic reactor, only 86/138 or 62% of the vaporous C6H6+3H2 mix exiting the endothermic reactor is required for preheating the C6H12 from 585 K to 1,400 K, and 38% or about 52 kJ/mol of thermal energy is available for other uses.
6. Following the cooling of the 62% and 38% streams of vaporous C6H6+3H2 mix to about 585 K (point W), the two streams will be recombined. The total product mix will then be used to supply their total amount of condensation thermal energy to the vaporization of the 100% C6H12 stream.
7. The H2 will then be cooled at constant pressure from 585 K to the presumed ambient temperature of 322 K (point U). Per the CGLC as shown above, 3 moles of H2 at 40 Atm and about 585 K have a volume of about 3.6 L. Reducing the temperature of the H2 at a constant pressure of 40 Atm to 322 K would reduce the volume to 2.0 L (0.071 cu ft).
8. The H2 will then be taken into a positive displacement expander. The generated force from the intake is equal to a piston 0.071 square feet or 10.2 square inches in area lifting 40 Atm or 588 pounds per square inch 1 foot, or about 3,000 foot-pounds, or 4.0 kJ Wout per stroke.
9. The H2 is then adiabatically expanded to 1 Atm. Per the CGLC, 3 moles of H2 at 322 K and 40 Atm expanded adiabatically to 1 Atm would have a final volume of 27.4 L (0.97 cu ft), a final temperature of 111 K and generate a force of 13 kJ Wout per stroke.
10. The H2 would then be exhausted at 1 Atm The required force for the exhaust is equal to a piston 0.97 square feet or 140 square inches in area lifting 1 Atm or 14.7 pounds per square inch 1 foot, or about 2,058 foot-pounds, or 2.8 kJ Wout. Expander net work out per stroke equals the work of constant pressure intake plus the work of adiabatic expansion minus the work of constant pressure exhaust or 14.2 kJ.

Total B/E CPR half-cycle Wout per stroke is thus equal to the expander work out minus the ENREC work in minus the pump work in. However, a hydraulic motor driven by the exhausting pressurized liquid C6H6 can serve to power the hydraulic pump required to pressurize the liquid C6H12. In addition, 38% of the latent heat in the product between 1,400 K and 322 K or a total temperature difference of 1,078 K, is available to power a bottoming cycle heat engine. Assuming a 30% thermal efficiency minimum, Wout from the endothermic bottoming cycle engine equals 25.8 kJ. Assuming the ENREC Win equals 0.5 kJ, total Wout thus equals approximately 39.5 kJ.

As noted above, one means for making available the 38% quantity of latent heat noted above to heat engines is to physically separate out 38% of the product stream exiting the endothermic reactor (see Ser. No. 18/362,951, paragraphs 607, 624, 625, and 626). The high quality latent heat available in the separated 38% product stream could then, for example, supply heat to a heat engine's working fluid, converting said 38% “excess” latent heat into the production of Wout. In one iteration, a thermal exchange would be made to take place between the outflowing 62% product stream at constant pressure and the inflowing C6H12 vapor reactant stream at constant pressure. This thermal exchange would cease at a temperature just before the product's vaporous C6H6 (and any remnant C6H12) condenses, at which time the cooled ˜38% vaporous product stream would be recombined with the ˜62% vaporous product stream. Following recombination of the two streams, the near-vaporous liquid C6H12 reactant would be vaporized in order to help cool and condense the vaporous C6H6. The heat of condensation of the product's higher pressure liquid constituents would thus essentially be used to preheat and vaporize the hot lower pressure stream of liquid C6H12 reactant. Finally, following the vaporization of the lower pressure C6H12, the C6H12 vapor would be increased in pressure using an ENREC (see Ser. No. 18/362,951, paragraph 606) to match the pressure of the now-liquid product stream, following which the inflowing pressurized vaporous reactant would be preheated to the temperature of the endothermic reactor by the outflowing higher pressure vaporous C6H6 plus H2 mix, as proposed above.

Via the act of constant pressure condensation of the higher pressure C6H6, the higher pressure gaseous H2 in the product stream is automatically separated out from the liquid C6H6, and can then be treated as a separate pressurized gaseous H2 product stream from that point on. H2 at 40 Atm being a gas down to temperatures approaching 20 K, any pressurization of the H2 during the B/E CPR process thus becomes available as potential adiabatic expansion energy. For example, by cooling the pressurized H2 to ambient temperature, an adiabatic expansion to ambient pressure can create a decreasing of the H2's temperature below ambient temperature. Importantly, the higher the H2 pressure, the farther below ambient the temperature can drop to a given final expansion pressure.

### B/E Chemical Pump Refrigeration Full Cycle

Since endothermic conversion of C6H12 in a catalytic reactor at high temperature and pressure will thermochemically capture a large amount of thermal energy, this chemically absorbed thermal energy must be taken into account when analyzing the overall thermal efficiency of the B/E CPR half-cycle. In the B/E CPR half-cycle, an ensuing conversion back to C6H12 exothermically releases all of the previously endothermically-captured thermal energy, albeit at a lower temperature/pressure regime. It has earlier been proposed (see U.S. patent application Ser. Nos. 17/746,848, 18/095,463, 18/197,092, and 18/362,951) that exothermically-produced thermochemical heat energy could be used to preheat a second heat engine's working fluid. This process is termed an exothermic half-cycle, so called because returning the C6H6+3H2 into C6H12 is useful for creating Wout independently of an original B/E Cycle.

In other words, endothermically-stored thermal energy of C6H6+3H2 remains potentially available. In one instance, that stored thermal energy can be used to power (or partially power as a preheater) a heat engine, producing work at the efficiency of that heat engine. If the heat is used as preheat, and source heat then raises the temperature to a higher heat, then per the Carnot Cycle the potential thermal efficiency of that heat engine determines the thermal efficiency at which that preheat thermal energy is used. For example, in the instance that the source equals 1,400 K and the sink equals 322 K, the theoretical work per the Carnot Cycle equals 77% efficiency, and that is the efficiency at which any preheating thermal input, which is by definition a part of the source heat, is calculated.

When used in this way, a B/E CPR half-cycle can be seen as a B/E CPR full cycle. The total thermal efficiency of the process is then found by (1) summing the net power output of the proposed H2 expansion refrigeration endothermic half cycle and the net power output of the heat engine process driven by heat or preheat produced by an exothermic half cycle, (2) summing the total thermal source inputs for both systems, and (3) dividing the total net power output of the two systems by their total thermal source input. Having done so, a B/E CPR full cycle's overall thermal efficiency can then be compared to the overall thermal efficiency typically required to presently accomplish the same amount of refrigeration.

Assuming the 218.7 kJ/mol produced by the exothermic reactor can also achieve a 30% minimum thermal efficiency, an exothermic bottoming cycle engine would generate 65.6 kJ Wout. Total Wout from the combined endothermic and exothermic heat engines would thus equal 105 kJ.

One means of comparing a B/E CPR full cycle to existing means of creating refrigeration is to compare the coefficient of performance (COP) for each approach. To determine the theoretical COP of existing refrigeration systems, a Carnot heat pump can be theorized:
1. Assume use of an electric-powered Carnot heat pump, which is the opposite of a Carnot heat engine. A Carnot heat engine is defined by T_{H}−T_{L}/T_{H}, where T_{H} equals the highest temperature and T_{L} equals the lowest temperature. A Carnot heat pump is therefore defined by T_{L}/T_{H}−T_{L}.
2. The coefficient of performance (COP) for a Carnot heat pump is defined as the ratio of useful cooling energy or Qc divided by the electrical work required to generate the cooling energy, or Wₑₗ. The COP of a Carnot heat pump is thus defined as:

$$C O {P}_{Carnot} = {Q}_{C} / {W}_{el} = {T}_{L} / {T}_{H} - {T}_{L}$$

Assuming a B/E CPR full cycle as described above, the highest temperature at 40 Atm equals 322 K and the lowest temperature at 1 Atm equals 111K. Therefore, COP_{Carnot} equals 111/(322-111) or 0.53, and Wₑₗ would equal 1.8868.

Real world heat pumps achieve Carnot efficiencies of about 50 to 60 percent. At 60% of Carnot, it would take 1.66 times the electrical power or Wₑₗ of 3.14 to achieve the same amount of cooling as a perfect Carnot heat pump. However, that is electrical energy. If a heat engine that has a thermal efficiency of 33% is used to generate the electrical energy, then overall efficiency in terms of converting heat into refrigeration is reduced to a third of the 60%, requiring 5 times as much source heat as required by a perfect Carnot heat pump or Wel of 9.43.

However, in this case, the B/E CPR full cycle that created the refrigeration not only didn't require any Win, it actually generated Wout in addition to the theoretical refrigeration Win. Thus, to be comparable, the normally required refrigeration Win must be computed and then added to the B/E CPR full cycle Wout. Since no excess Win was required, the 0.53 COP can be taken as the real-world COP. Per the CGLC, 3 moles of H2 at 1 Atm and 111 K has an initial volume of 27.3 L. To reach a final temperature of 322 K, the final pressure, not coincidentally, must equal 40 Atm and the final volume must equal about 2 L. The Win equals about 12.9 kJ. Calculating the real world work required by an adiabatic compression of 3 moles of H2 from 111 K to 322 K means dividing that Win by 0.53. The comparable work required to generate that COP would thus equal 24.5 kJ, or a sum of B/E CPR full cycle Wout plus normal refrigeration “work avoided” of 135 kJ. Net thermal efficiency would thus equal the sum total of otherwise-required refrigeration Win and B/E CPR full cycle Wout or 135 kJ divided by the total Hin or 218.7 kJ or 62%. Thus, even assuming a very moderate 30% thermal efficiency for converting the source Hin to net Wout for each of the two half-cycles, the B/E CPR full cycle, from a source heat perspective, promises to be accomplished significantly more efficiently than present systems.

FIG. 7 schematically illustrates one possible way to combine a B/E CPR half-cycle and a B/E exothermic half-cycle to create, in this instance, a B/E CPR full cycle. In this instance, the exothermic half-cycle is a “bi-pressure exothermic half-cycle”, shown in FIG. 4 and in FIG. 7 by the lines through the points A, D, E, F, G, H, I, J, A. The B/E CPR half-cycle illustrated is similar to the, the C6H12/C6H6 liquid/vapor portion of the cycle is shown in FIG. 4 and in FIG. 7 by the lines through the points A, U, V, W, X, W, U, A, while the gaseous H2 varies at the end of the half-cycle by traveling by the lines through the points X, W, U, AG, J. In FIG. 7, the various points defining the various stages in this particular B/E Chemical Pump Refrigeration full cycle are noted in the schematics of the two intertwined cycles at the points where those changes are expected to have occurred.

Unlike the B/E CPR half-cycle shown earlier, defined by an expansion to 1 Atm (point Y), this particular B/E CPR half-cycle ends expansion at 2 Atm (point AG). That avoids having to recompress the H2 gas to match the pressure of the C6H12 exiting the ENREC., slightly simplifying the overall process.

Finally, as stated in USPTO application Ser. No. 17/746,848, B/E Cycles may be particularly efficacious on the lunar surface, where, due to the lack of an atmosphere, cold sinks can be found at the lunar poles in a Permanently Shadowed Region (PSR) or even be artificially created in an Artificial PSR (APSR). A lunar PSR/APSR should increase the ability to chill H2 to “ambient” temperatures approaching 200 K prior to expansion, much lower than is possible on Earth. That in turn should make it possible to create an even more thermally efficient B/E CPR cycles, because of (1) the ability to chill the proposed H2 refrigeration expansion half cycle's pressurized H2 from a lower ambient temperature, and (2) the ability to create a lower sink (versus source) temperature for heat engines generally.

### Surfeit C6H12 Stream Heat Engine Design

While the above describes a process whereby the use of an endothermic process to thermochemically create a supply of higher pressure H2 that can be then cooled to ambient and expanded to create cold, it is also possible to create a half-cycle that instead expands the endothermically-produced C6H6+3H2 stream to create net Wout. An interesting alternative for making the ˜38% quantity of latent heat contained in the C6H6+3H2 stream available as an integrated heat engine is to purposefully supply a surfeit of the vaporous C6H12 content of a B/E Cycle engine and use it to enhance the Wout; that is, (1) use the total latent heat content to raise the temperature of the oversupplied C6H12 to the endothermic reaction temperature, then (2) separate the C6H12 high temperature vapor into two streams before it enters the endothermic reactor. The non-converted C6H12 stream would then be expanded to produce net Wout, cooled, pumped back up to input pressure, and recycled, while the converted portion would be used to preheat the initially supplied quantity of C6H12 and to produce pressurized H2 gas. In essence, sufficient surfeit of C6H12 vapor would be pumped in to utilize the excess latent heat in the product mix exiting the endothermic reactor. Thus, an additional 0.38 moles of high pressure vaporous C6H12 per mol of converted C6H12 can theoretically be added to the reactant input, passed through the ENREC, preheated to the temperature of the endothermic reactor, “separated out” at peak temperature prior to the 0.62 moles entering the endothermic reactor, then be expanded to produce Wout.

However, the requirement to convert the surfeit C6H12 from liquid into vapor would require an additional thermal input, reducing thermal efficiency. In the “summer”, that excess thermal energy requirement could be met by using an exothermic half-cycle, but in the winter, it would need to come from the heat source.

Finally, note that, in a design intended to create maximum Wout, the surfeit C6H12 and the C6H12 converted to C6H6+H2 could be expanded in a single expander, since they are at the same pressure and temperature when the C6H6+H2 exits the endothermic reactor. After final exhaust, the C6H6 and C6H12 would then need to be separated, as for example by use of a centrifuge that separates the “heavier” C6H6 from the “lighter” C6H12.

### Supercritical C6H12 Steam Heat Engine Design

It is possible to generate even more Wout with surfeit C6H12 pumped and heated to a supercritical state while attaining decent thermal efficiency. FIG. 4 illustrates an endothermic half-cycle that operates at the “supercritical” temperature and pressure for C6H12, estimated at about 39 Atm and 578 K (1040 R). Such as cycle avoids the Win “cost” of a high pressure vapor compressor. It is assumed in FIG. 4 that an ENREC compression from 39 Atm to about 40 Atm is sufficient to convert all the C6H12 into vapor, from which state it may be superheated to the required endothermic reactor temperature, shown in FIG. 1 and FIG. 2, of about 1,400 K (2,520 R) for a 99% conversion and 1,230 K (1,754 R) for a 90% conversion. Note from the “C6H12 expander heat engine process” described above that a surfeit of C6H12, expanded for example from 40 Atm to 2 Atm, still equals a temperature of about 600 K (1,080 R) and is decidedly still a vapor, and thus significant vaporous latent heat remains available to transfer heat into and vaporize, for example, an additional stream of surfeit liquid C6H12 at 39 Atm (after which the thermally exhausted surfeit C6H12 may be condensed back to liquid, recompressed to 39 Atm, and be recycled back through the mechanism). In other words, the 600 K vapor heat capacity available in an expanded C6H12′s exhaust can theoretically supply the latent heat requirement of additional high pressure C6H12 liquid, allowing it to achieve the supercritical temperature of about 1,040 R (578 K) modeled in FIG. 3. Note that the liquid molar heat capacity of C6H12 is equal to 156 J/(mol K), and the vapor molar heat capacity of C6H12 is equal to 105 J/(mol K). Thus, the remaining vapor molar heat capacity in the exhausting C6H12 can supply an additional 67% quantity of the surfeit C6H12′s initial quantity of 0.38 moles, meaning an additional 0.25 moles of C6H12 can be added to the surfeit. However, after bringing the additional 0.25 moles of surfeit C6H12 vapor to its supercritical temperature, the additional 0.25 moles must then receive additional thermal energy from the primary heat source to reach peak temperature, in this instance about 1,400 K (2,520 R), following which the superheated surfeit C6H12 steam can be expanded to produce yet more Wout. That addition of 0.25 moles will, of course, yet again increase the remaining vapor molar heat capacity in that additional surfeit quantity of expanded C6H12 vapor, and so on. Eventually, additional moles of surfeit C6H6 will “top out”, to finally equal an estimated additional surfeit 0.3 moles in total. That would potentially equal a final C6H12 surfeit of about 0.68 moles, while requiring some commensurate amount of additional source heat between 600 K and 1,400 K for the ˜0.3 moles of additional surfeit C6H12.

Note that such a “supercritical C6H12 steam heat engine design” process can function beneficially when the “freed” H2 gas will be cooled to act as a refrigerant, which is most useful during the lunar “summer” when cooling is desirable. However, much the same process can be applied to constructing an engine that is designed to maximize Wout, for example during the 2 week long lunar “winter”. As stated above, for a maximum Wout production design, the C6H6+3H2 product mix exiting the endothermic expander can be “mixed” with the surfeit C6H12 which is at the same pressure and temperature, and the sum total can then be expanded to produce Wout.

Recall that, during the lunar “winter” power generation phase (see Ser. No. 18/197,092 and Ser. No. 18/362,951), the H2 exhausting from the B/E Cycle work-producing engine will be consumed by (1) the thermochemical expansion heat engine that produces net H2, and (2) a fuel cell (the O2 constituent of which, over the lunar “summer”, was generated by electrolysis of H2O). That is, in the “winter”, the proposed cycle may produce (1) H2 for powering a fuel cell, (2) high temperature H20 exhaust, and (3) Wout of thermal expansion. Once again, overall thermal efficiency will be a function of all the net Wout/electricity produced divided by the net thermal input. In essence, increasing the overall efficiency of the high pressure heat engine cycle releasing the H2 reduces the overall amount of H2 that needs to be burned for a given quantity of heat engine Wout. Thus, when summing the source heat absorbed during the “summer” to (1) make H2 and (possibly liquid) O2 via electrolysis and to (2) power the B/E CPR refrigeration engine, the thermal energy from combusted H2 driving the “winter” heat engine that releases the H2 is not to be included as source heat. Rather, that source heat is controlled by the efficiency of (1) electrolysis of H2O into H2+O2 and (2) the efficiency of the thermal energy process that creates the electricity for electrolysis in the first place.

### The Thermochemical Bootstrap Concept

In the “winter” endothermic half-cycle, the liquid C6H12 used as a “Thermochemical Gas Compressor” plus the ENREC can be seen as the “compressors” for the heat engine. In the “summer” exothermic half-cycle, in the most obvious pathway, the required pressurized H2 may be physically compressed. However, there is an interesting alternative:

In the lunar “summer”, there is the possibility of adding even more surfeit super-critically-heated liquid C6H12 to a work-producing exothermic half-cycle by utilizing thermal energy released by the combination of a portion or all of the available C6H6+3H2 to provide sufficiently high temperature thermal energy to preheat and thus create additional supercritical C6H12. Recall that the temperature generated by exothermic reformation of C6H6+3H2 into the reactant C6H12 is completely dependent on the pressure of the products and the percentage of conversion.

The energy required to increase the 39 Atm liquid C6H12 from 389 K to 598 K or 211 K total temperature change is assumed to equal the sum of the liquid heat capacity at that temperature difference, or (0.156×211=) 33 kJ. The final “supercritical” temperature is estimated to be about 602 K. Recall that the 99% complete exothermic reaction will evolve ˜52.28 kcal/mol (218.7 kJ/mol) of thermal energy, therefore a 90% reaction will evolve about 197 kJ. Note that this amount of chemically absorbed thermal energy per mol of C6 H12 produced is the same regardless of the temperature/pressure setting Assuming a 90% conversion at a product mix pressure of only 2 Atm, exothermic reactor thermal energy is available at 680 K. Thus, reacting 0.9 moles of C6H6 and 2.7 moles of H2 at 2 Atm will evolve enough energy to preheat (197/33=) 6 moles of C6H12 to vapor at about 602 K. That is, converting 0.15 moles of C6H6 and 0.45 moles of H2 at 2 Atm supplies enough thermal energy to convert a mol of C6H12 at 39 Atm to supercritical vapor. This has the effect of increasing the thermal efficiency of that portion of product mix thus used and thus increasing the thermal efficiency of the exothermic half-cycle itself.

In the system just described, a portion of exothermically produced product is used to preheat an endothermic half-cycle, thus increasing the potential of both the endothermic half-cycle and utilizing some portion of the exothermically-produced heat to good effect, essentially increasing the potential thermal efficiency of the exothermic half-cycle as well. In a second instance of preheating an endothermic reaction with the thermal output of an earlier exothermic reaction, consider the endothermic conversion of C6H12 reactant into C6H6+H2 product at “supercritical” pressure for C6H12, or about 40 Atm. As in the system described above, it is possible to divert a portion of product mix that is released by a previous endothermic reaction operating at 40 Atm to similarly pass through an exothermic half-cycle, thus using the resulting product mix to preheat the C6H12 reactant, but in this instance at a much higher pressure and temperature, increasing both the thermal efficiency of that higher pressure exothermic half-cycle and the thermal efficiency of the endothermic half-cycle that uses that previously thermochemically-stored energy to good effect. In other words, an exothermic half-cycle can be used to “bootstrap” a following endothermic half-cycle to a higher level of thermal efficiency.

Finally, it is possible to visualize creating “multi-staged” exothermic reactor-powered preheats, where lower pressure exothermic reactions generate heat to reach temperature A, higher pressure exothermic reactions generate heat to reach a higher temperature B, and so on, collectively driving the amount of recycled thermal energy higher to some eventual limit. Note that, once the product mixes for each stage are converted back into a liquid reactant, the liquid reactant can be recycled to the desired pressure by (1) simple pump pressurization and (2) use of an ENREC, completely side-stepping the seeming requirement to highly compress a vapor or gas to complete the exothermic half-cycle.

### The Benzene Battery and refrigeration

One specific application of the B/E Cycle was proposed, in Ser. No. 18/197,092, as a means of increasing the usefulness of a “Benzene Battery” (BB) in a lunar power application. Essentially, one configuration of the BB may be seen as configuring a special type of “Regenerating Fuel Cell” (RFC) system, termed a BB RFC.

In a NASA concept study from 2009 entitled “NASA JSC Lunar Surface Concept Study Lunar Energy Storage” by Dr. Cheng-Yi Lu and Jim McClanahan, both a High Pressure Storage RFC (HP RFC) system and a cryogenic RFC (Cryo RFC) were proposed as possible systems for storing electrical energy on the lunar surface. It's handy to think of a lunar “rotation” around the Earth as equal to about 4 weeks in length, with 2 weeks of extreme “summer” and 2 weeks of extreme “winter”. It was proposed (slide 48) that 2,000 kWh electrical energy be stored in either an HP RFC or a Cryo RFC during the lunar summer and taken out of storage during the lunar winter.

### The RFC System

In a RFC system, a fuel cell is used to create electricity from H2 and 02, which results in the production of H2O (water). That H20 is later dissociated via electrolysis back into H2 and O2. In the 2009 NASA study, an advanced fuel cell was assumed to create electricity at an estimated thermal efficiency of 70% of the heat of combustion of H2 and O2, and the electrolysis was assumed to convert electric energy at an estimated efficiency of 93% of the heat of combustion of H2 and O2. The overall efficiency of the cycle is therefore theoretically very efficient, estimated at 0.7×0.93 or 65% for the advanced NASA system.

### The NASA HP RFC System

In the 2009 NASA concept study's HP RFC system, tanks were used to contain pressurized H2 and O2. Comparisons between the various proposed systems is difficult, since the systems analyzed by NASA are not perfectly similar. For example, the HP fuel cell system operates at 353 K and produces electricity at a 65% efficiency, while the Cryo fuel cell system operates at 393 K and produces electricity at a 70% efficiency. Presumably due to the lower efficiency of the proposed fuel cell, the reactant masses of O2 and H2 are higher for the HP RFC system (a combined tank plus reactants mass of 3,150 kg for the HP system is shown versus 1,172 for the Cryo system). The shown tank masses for the HP system equaled 2,312 kg and 393 kg for the Cryo system. To make the reactant numbers of the two systems comparable, the tank mass number for a NASA HP RFC system can be reduced to 65/70ths of the NASA Cryo RFC system, or 2, 147 kg. That would equal a mass sum of tanks and gaseous (HP) constituents of 2,926 kg. Note that this does not include the mass of the solar energy power generation system, which would be likely equal to that of the “Additional Solar array Power for Energy Storage” component, which, per slide 51, equals 26 kg for the HP tank system and 17 kg for the matching Cryo system.

A separate question concerns the overall thermal efficiency of the system. This is more difficult to parse from the information given in the 2009 NASA study slides. Since, for the NASA RFC systems, that extra energy to “charge” the system (by electrolysis of H2O into H2 and O2) must be acquired during the lunar summer, in addition to the normal 5 kWe of constant generation and usage, then the solar system for the winter would need to at least equal the solar system for the summer plus any built-in inefficiencies that the storage approach creates. Thus, in the case of Li-Ion Battery storage, per slide 15, that inefficiency equals 5% for the battery and an additional 5% for “Elect. Power Conversion” or a total of about 90% overall efficiency. Note that the NASA RFC systems replaces the Li-Ion system (and the DDCU system, since electrolysis requires direct current).

From slide 13, we know that the solar electrical power generation system would have a specific power output of 130 W/kg and employ “CPV” (which is assumed to stand for Concentrated Photo Voltaic) technology Assuming the same is true on the surface to produce the 28% solar insolation conversion efficiency, the total mass would equal (2000/130=) 15.4 kg, which seems to match well with the mass requirements shown in slide 51. Thus, 15.4 kg of CPV on the lunar surface would generate 2,000 kWe. Since the moon on average has a rotational speed of about 682 hours per revolution, that equals 3,410 kWe for a complete lunar revolution at 5 kWe/hour. From slide 15, “Energy Storage Architecture Surface Power Only Element”, we know that ideally 28% (using “5J”) of the total solar insolation would generate 2,000 kWe-hr, 95% of which would be “lost” to a Li-Ion battery and another 95% of which would be “lost” to electrical power conversion, dropping output by about 90% to 1,805 kWe-hr, or 5 kWe produced continuously for (1805/5=) for 361 hours. That means we'd need an additional (3410-1805=) 1605 kWe to cover a whole solar revolution, or (1605/130=) an additional 12.3 kg of CPV, or a total of (15.4+12.3=) 27.75 kg of CPV if we used the Li-Ion battery solution. Thus, 27.75 kg of CPV would generate (130×=27.75) 3,607.5 kWe, all at a thermal efficiency of about 28%.

Overall thermal efficiency of the NASA Li-Ion battery system would thus equal the (5×682=) 3,410 kW-hours output of 5 kWe generation divided by the total power requirement of solar insolation times the efficiency of solar insolation conversion. Overall efficiency thus equals ((3,410/3607.5)×0.28=) 26.5%.

However, the NASA RFC system has additional electrical costs, as delineated in slide 51. Some hint of the extent of the additional NASA HP RFC electrical costs can be drawn from the required 26 kg “Additional Solar Array Power for Energy System” shown in slide 51. Thus, (15.4+26=) 41.4 kg of CPV would generate (130×41.4=)5,382 kWe, all at a thermal efficiency of about 28%. Per slide 51, that would in turn create 8.7 kWe “Power for Charging”, presumably over the summer hours. Since the moon on average has about 682 hours per revolution, that leaves 321 days of “full lunar summer” to harvest solar insolation. Assuming 1,805 kW-hr are needed, at 8.7 kWe per hour, 207.5 hours of summer insolation would be required. This may be reasonable, since the the sun must rise sufficiently above the lunar horizon for a CPV concentrator to “see” it, which means that there will be decidedly less summer hours of solar insolation available than winter hours.

Overall thermal efficiency of the NASA HP RFC system would thus equal the (5×682=) 3,410 kW-hours output of 5 kWe generation divided by the total power requirement of solar insolation times the efficiency of solar insolation conversion. Since total output equals 3,410 kWe at a 28% efficiency, overall efficiency thus equals ((3410/5382)×0.28=) 17.7%.

### The BB HP RFC System

In the BB HP RFC system, the H2 would be stored in hydrocarbon form, as in C6H12 that reversibly converts to C6H6 and 3H2. The O2 would be stored as a gas at high pressure. Note that the required O2 would equal the same mass as the other systems discussed above.

In the 2009 NASA concept study's HP RFC system, it is not shown what the relative mass of the O2 storage tank is versus the H2 storage tank, but it is possible to make an estimate:
It will require 2 moles of H2 for every mol of O2.
H2 at STP has a density of 0.0899 kg/m3)/mol and a mol has a mass of 2.016 g. For a mass of 87 kg at STP, volume would equal (87/0.0899=) 967.742 m3.
O2at STP has a density of 1.429 kg/m3 and a mol has a mass of 32 g. For a mass of 692 kg at STP, volume would equal (692/1.429=) 484.255 m3.
For a given pressure, wall thickness is a function of size. Assuming the same size for O2 and H2 tanks, wall thicknesses would be the same. Thus, storing the H2 would require twice the number of tanks of the same size as the O2 tank.

Since we know the mass of the combined tanks (2, 147 kg), the mass of the O2 tank would therefore equal (2147/3=) 716 kg.

As proposed in U.S. patent application Ser. No. 18/197,092, the liquifying and storing of H2 would be replaced by the storage of H2 in C6H12. From the application:
“The total mass of H2 required for electrolysis, as in the NASA RFC, equals 87 kg of H2. For a BB RFC system, that would require 43,000 moles of H2. At 3 moles per mol of C6H12, total C6H12 required equals 1,108 kg . . . ”

1,108 kg equals 857.6 liters equals 0.8575 cubic meters, Assuming the C6H6 and the C6H12 liquids “share” the same storage tank with a simple separator means between them, that would equal a cylindrical tank about a meter in height and slightly over a meter in diameter. For a shared C6H12/C6H6 tank, a reasonable estimate of 100 kg will be assumed.

There remains the question of overall relative thermal efficiency, which will impact the amount of reactants required and thus the overall system mass. In a BB, about ⅓ of the H2 needs to be combusted in order to “free” the other ⅔ of the H2. However, the H2 and O2 thus consumed in both the endothermic reactor half-cycle during the lunar winter and the exothermic reactor half-cycle in the lunar summer will simultaneously produce Wout. In other words, the ⅓ energy consumed in the lunar winter is not “lost” but is thermochemically captured inside the reaction and will be “released” in the lunar summer, where it is used to increase the thermal efficiency of a heat engine, such as a solar-powered heat engine converting sunlight to Wout to electricity. The thermal efficiency of lower grade heat used to increase the overall efficiency of a heat engine is taken to equal the overall thermal efficiency of said heat engine. As a result, a highly efficient engine process that utilizes said lower grade heat may balance out or possibly exceed the overall thermal efficiency of the NASA HP RFC system.

Overall system efficiency of a BB is found by dividing the total net power output of the two systems by their total thermal source input. Assuming an overall 65% thermal efficiency for both half-cycles is produced, total mass of the BB HP RFC system for the “liquid” plus “gaseous” constituents plus the tanks plus the incidental mass would thus equal (87+692+716+1,108+100=) 2,703 kg, or slightly less than the estimated 2926 kg of the NASA HP RFC system.

### The NASA Cryo RFC System

In the Cryo RFC system, an equal mass of H2 and the O2 are stored, but as cryogenic liquids. The kW-hr/kg of a Cryo RFC was estimated to equal 1.153 for a 1,760 kg system. Of that total, the tanks massed 393 kg, the drying/liquifying equipment massed 104 kg, the power required for cryogenic storage massed 267 kg, and additional equipment added 10 kg, for a total mass including the cryogenic liquids of (779+393+104+267+10=) 1,553 kg. Note again that this does not include the mass of the solar energy power generation system.

### The BB Cryo RFC System

In this system, only the O2 would be liquified, as in the NASA C RFC system. From No. 18/197,092:
“It is known that, for the NASA RFC, 87 kg of liquid H2 and 692 kg of liquid O2 were proposed. The total mass for both H2 and O2 cryogenic storage tanks is estimated at 393 kg. The individual mass for the H2 and O 2 tanks is not given. However, we know that liquid H2 has a density of 70.85 g/L and that liquid 02 has a density of 1.141 kg/L. For 87,000 g of liquid H2, volume would equal (87,000/70.85=) 1,228 L. For 692 kg of liquid 02, volume would equal (692/1.141=) 606 L. That is an H2 to O2 volume ratio of (1,228/606=) about 2 to 1. Since H2 must be far more extensively insulated than O2, and since pressure is not an issue, it is reasonable to assume that the H2 tank has twice the mass of the O2 tank, and [the O2 tank] is thus equal to about (393/3=) 131 kg. For the BB Cryo RFC cryogenic O2 storage system, additional mass will be considered equal to about half of the NASA Cryo RFC system, or about 190 kg.”

Assuming the C6H6 and the C6H12 liquids “share” the same storage tank with a simple separator means between them, that would equal a a tank about a meter in height with a diameter of about 1.34 meters. A reasonable estimate of it's mass of 100 kg will be assumed. Total mass for the “liquid” constituents of the system would thus equal (692+1,108=) 1,800 kg. The total tank plus incidental mass would thus equal (131+100+190=) 421 kg. Total mass for tanks and constituents equals 2,221 kg, or about 43% more massive than the NASA Cryo RFC system.

### The BB Cryo+ RFC System

There is one interesting possible means to further reduce the mass of the BB Cryo RFC system, termed the BB Cryo+ RFC system, and that is by integrating it with the refrigeration system proposed in No. 18/362,951 and above. Doing so will theoretically further decrease the mass of the BB Cryo RFC system by reducing the mass of the HP O2 storage tank via storage of liquid O2 at low pressure. The BB Cryo+ RFC system utilizes the unique ability of a B/E CPR to efficiently create liquid O2 while simultaneously creating net Wout during the lunar summer's endothermic half-cycle.

This is especially beneficial if the system is arranged to take advantage of either a Permanently Shadowed Region (PSR) or artificial PSR (APSR). PSR's can be found at the Moon's two poles, and are a direct result of the orbit of the Moon being essentially parallel to the orbit of the Earth around the Sun. As a result of that parallel orbit, any crater at or near either lunar pole has elements within it that never see sunlight. An APSR is essentially a region that either extends the area of a PSR or creates a PSR artificially, by creating a permanently shadowed region with a solar shield of some kind. Note that in the Moon's polar regions, such an APSR could be made by simply putting up a fence, since the Sun's rays run essentially parallel to the surfaces of the lunar poles. At the equator, however, an actual “tent” or “parasol” arrangement would be required.

The usefulness of a PSR or APSR to an RFC system clearly concerns the ability to have deeper “source cold” available, akin to running a heat engine that requires a heat sink in a cold climate versus a hot climate. Also, it requires less Win in such a climate to maintain, for example, O2 as LOX. As mentioned earlier, for the BB Cryo+ RFC system, the existence of a PSR or APSR would allow a lower H2 expansion temperature to be achieved. It is theoretically possible that, with a sufficiently low temperature PSR or APSR, a sufficiently lower H2 post-expansion temperature may be achieved such that the expanded H2 can itself produce LOX with a single pass through a counterflow heat exchanger.

What is claimed is:

1. A method for utilizing the Bland/Ewing cycle as a thermochecmical gas compressor substantially as shown and described.
